(19) United States
(12) Patent Application Publication
(10) Pub. No.: US 2020/0159326 A1
(43) Pub. Date: May 21, 2020

(54) SYSTEMS AND METHODS FOR PROVIDING HAPTIC FEEDBACK RELATED TO LIFTING OR MANIPULATING A VIRTUAL OBJECT

(71) Applicant: IMMERSION CORPORATION, San Jose, CA (US)

(72) Inventors: William S. RIHN, San Jose, CA (US); Colin SWINDELLS, San Jose, CA (US)

(21) Appl. No.: 16/197,949

(22) Filed: Nov. 21, 2018

(51) Int. Cl. G06F 3/01; G06F 3/0346

(52) U.S. Cl. CPC G06F 3/016; G06F 3/0346

(57) ABSTRACT

A hand-held device for providing haptic feedback includes an elongated housing, a mass, a mass restriction device, a first sensor and a second sensor. The elongated housing includes at least two chambers. The mass is slidably disposed within the chambers and is slidable by gravity. The mass restriction device restricts the mass within at least one of the chambers. The first sensor is configured to sense an orientation of the elongated housing and the second sensor is configured to sense a location of the mass within the elongated housing relative to the chambers. In response to a command signal indicative of a virtual interaction related to manipulating a virtual object, the mass restriction device restricts the mass within at least one of the chambers to effect a perceived change in weight as the virtual object is manipulated by the user.

### FIELD OF THE INVENTION

Embodiments hereof relate to haptic feedback, and more particularly relate to haptic feedback indicative of a virtual interaction related to lifting or manipulating a virtual object.

### BACKGROUND OF THE INVENTION

Video games and video game systems have become ever more popular due to the marketing toward, and resulting participation from, casual gamers. Conventional video game devices or controllers use visual and auditory cues to provide feedback to a user. In some interface devices, kinesthetic feedback (such as active and resistive force feedback) and/or tactile feedback (such as vibration, texture, and heat) is also provided to the user, more generally known collectively as “haptic feedback” or “haptic effects”. Haptic feedback can provide cues that enhance and simplify the user interaction or user experience. Conventional haptic feedback systems for gaming, virtual reality, augmented reality, and other devices generally include one or more actuators, attached to or contained within the housing of a hand-held controller/peripheral for generating haptic feedback.

Embodiments hereof relate to haptic feedback indicative of a virtual interaction related to lifting or manipulating a virtual object.

### BRIEF SUMMARY OF THE INVENTION

Embodiments hereof relate to a hand-held device for providing haptic feedback. The hand-held device includes an elongated housing configured to be held by a user, a mass slidably disposed within the elongated housing, a mass restriction device, a first sensor configured to sense an orientation of the elongated housing, and a second sensor configured to sense a location of the mass within the elongated housing. The elongated housing includes a first end, a second end opposite the first end, and at least two chambers within the elongated housing. The mass is slidable between the at least two chambers by gravity, and is formed from a ferrous material. The mass restriction device includes an electromagnet disposed within the elongated housing, the electromagnet including an unenergized state configured to permit the mass to slide within the elongated housing and an energized state configured to restrict at least a portion of the mass within one of the at least two chambers. The second sensor is configured to sense the location of the mass within the elongated housing relative to the at least two chambers. The mass restriction device is further configured to receive a command signal and is configured to transition the electromagnet between the unenergized state and the energized state in response to the command signal.

Embodiments hereof also relate to a hand-held device for providing haptic feedback. The hand-held device includes an elongated housing configured to be held by a user, a mass slidably disposed within the elongated housing, a mass restriction device, a first sensor configured to sense an orientation of the elongated housing, and a second sensor configured to sense a location of the mass within the elongated housing. The elongated housing includes a first end, a second end opposite the first end, and at least two chambers within the elongated housing. The mass is fluidic and slidable between the at least two chambers by gravity. The mass restriction device includes a valve disposed between the at least two chambers of the elongated housing, and the valve includes an open state configured to permit fluid communication between the chambers adjacent the valve and a closed state configured to prevent fluid communication between the chambers adjacent the valve. The valve transitions between the open state and the closed state in response to a command signal. The second sensor is configured to sense the location of the mass within the elongated housing relative to the at least two chambers.

Embodiments hereof relate to a system for providing haptic feedback. The system includes a processor for generating a command signal indicative of a virtual interaction related to manipulating a virtual object and a hand-held device. The hand-held device includes an elongated housing, a mass slidably disposed within the elongated housing, a mass restriction device, a first sensor configured to sense an orientation of the elongated housing, and a second sensor configured to sense a location of the mass within the elongated housing. The elongated housing includes a first end, a second end opposite the first end, and at least two chambers within the elongated housing. The mass is formed from a ferrous material. The mass restriction device includes an electromagnet disposed within the elongated housing, the electromagnet including an unenergized state configured to permit the mass to slide within the elongated housing and an energized state configured to restrict at least a portion of the mass within one of the at least two chambers. The second sensor is configured to sense the location of the mass within the elongated housing relative to the at least two chambers. When the user changes the orientation of the hand-held device to manipulate the virtual object, the mass within the elongated housing of the hand-held device moves between the chambers by gravity. The mass restriction device is further configured to transition the electromagnet between the unenergized state and the energized state in response to the command signal.

### BRIEF DESCRIPTION OF DRAWINGS

The foregoing and other features and advantages of the invention will be apparent from the following description of embodiments hereof as illustrated in the accompanying drawings. The accompanying drawings, which are incorporated herein and form a part of the specification, further serve to explain the principles of the invention and to enable a person skilled in the pertinent art to make and use the invention. The drawings are not to scale.

FIG. 1 depicts a schematic illustration of a system including a hand-held device for providing haptic feedback according to an embodiment hereof, wherein the system also includes a host computer.

FIG. 2 depicts a block diagram of the system of FIG. 1.

FIG. 3 depicts a perspective sectional view illustration of the hand-held device of FIG. 1, wherein the hand-held device includes a ferrofluidic mass and a plurality of electromagnets according to an embodiment hereof.

FIG. 4 depicts a flow chart for providing haptic feedback indicative of a virtual interaction related to lifting and manipulating a virtual object with the hand-held device of FIG. 1.

FIG. 5A depicts a sectional view illustration of the hand-held device of FIG. 1, wherein the ferrofluidic mass is restricted in a first chamber of the hand-held device by a first electromagnet in an energized state.

FIG. 5B depicts a sectional view illustration of the hand-held device of FIG. 1, wherein the ferrofluidic mass is disposed within a sixth chamber of the hand-held device and each of the electromagnets is in an unenergized state.

FIG. 5C depicts a sectional view illustration of the hand-held device of FIG. 1, wherein the ferrofluidic mass is restricted within the sixth chamber of the hand-held device by the sixth electromagnet in the energized state.

FIG. 5D depicts a perspective sectional view illustration of a hand-held device according to another embodiment hereof, wherein the hand-held device includes an alternative configuration of a plurality of electromagnets.

FIG. 6 depicts a block diagram of a system for providing haptic feedback, wherein the system includes a hand-held device according to another embodiment hereof.

FIG. 7 depicts a perspective sectional view illustration of the hand-held device of FIG. 6, wherein the hand-held device includes a fluid and a plurality of actuator assemblies/valves disposed between adjacent chambers of the hand-held device.

FIG. 8 depicts a flow chart for providing a haptic effect indicative of a virtual interaction related to lifting a virtual object with the hand-held device of FIG. 7.

FIG. 9A depicts a sectional view illustration of the hand-held device of FIG. 7, wherein the fluid is restricted in a first chamber of the hand-held device by a first valve in a closed state.

FIG. 9B depicts a sectional view illustration of the hand-held device of FIG. 7, wherein the fluid is disposed within a third chamber of the hand-held device, and the plurality of valves are each in an open state.

FIG. 9C depicts a sectional view illustration of the hand-held device of FIG. 7, wherein the fluid is restricted within the third chamber by the second and third valve each in the closed state.

FIG. 10A depicts a perspective sectional view illustration of a hand-held device for providing haptic feedback according to another embodiment hereof, wherein the hand-held device includes a plurality of chambers along a first side of the hand-held device.

FIG. 10B is a cross-sectional illustration of the hand-held device of FIG. 10A taken at line 10B-10B of FIG. 10A.

FIG. 11 depicts a block diagram of a system for providing haptic feedback, wherein the system includes a hand-held device according to another embodiment hereof.

FIG. 12A depicts a perspective sectional view illustration of a hand-held device for providing haptic feedback according to another embodiment hereof, wherein the hand-held device includes a fluid and a plurality of bladder valves disposed between adjacent chambers of the hand-held device.

FIG. 12B depicts a perspective view illustration of the bladder valve of FIG. 12A, wherein the bladder valve is in the open state.

FIG. 12C depicts a perspective view illustration of the bladder valve of FIG. 12A, wherein the bladder valve is in the closed state.

FIG. 13 depicts a flow chart for providing a haptic effect indicative of a virtual interaction related to lifting a virtual object with the hand-held device of FIG. 12A.

FIG. 14A depicts a sectional view illustration of the hand-held device of FIG. 12A, wherein the fluid is restricted in a first chamber of the hand-held device by a first bladder valve in a closed state.

FIG. 14B depicts a sectional view illustration of the hand-held device of FIG. 12A, wherein the fluid is disposed within a third chamber of the hand-held device, and each of the plurality of bladder valves are in an open state.

FIG. 14C depicts a sectional view illustration of the hand-held device of FIG. 12A, wherein the fluid is restricted within the third chamber by the second bladder valve in the closed state.

FIG. 15 depicts a sectional view illustration of a hand-held device for providing haptic feedback according to another embodiment hereof, wherein the hand-held device includes a magnetic control valve disposed within an elongated housing.

FIG. 16 depicts a sectional view illustration of a hand-held device for providing haptic feedback according to another embodiment hereof, wherein each chamber of the hand-held device is defined by a deformable bladder.

### DETAILED DESCRIPTION OF THE INVENTION

Specific embodiments of the present invention are now described with reference to the figures, wherein like reference numbers indicate identical or functionally similar elements.

The following detailed description is merely exemplary in nature and is not intended to limit the invention or the application and uses of the invention. Furthermore, there is no intention to be bound by any expressed or implied theory presented in the preceding technical field, background, brief summary or the following detailed description. Furthermore, although the following description is directed to hand-held devices for providing haptic feedback in a virtual reality (VR) or augmented reality (AR) environment, those skilled in the art would recognize that the description applies equally to other haptic feedback devices and applications.

Embodiments hereof are directed to hand-held devices for providing haptic feedback related to lifting or otherwise manipulating virtual objects in a virtual reality or augmented reality environment. Specifically, the haptic feedback is in the form of mass or weight redistribution to effect a change in a center of gravity and a moment of inertia of a hand-held device to provide a perceived change in weight of the hand-held device. The perceived change in weight of the hand-held device creates greater sensory immersion within a simulated, virtual, or augmented environment. The hand-held device includes an elongated housing configured to be held in a hand of a user. The elongated housing includes at least two (2) chambers. The hand-held device further includes a mass configured to slide or otherwise move within the at least two (2) chambers of the elongated housing in response to gravity. Stated another way, as the elongated housing is tipped, tilted or reoriented by the user, the mass moves between the at least two (2) chambers of the elongated housing due only by gravity. In order to provide haptic feedback related to the manipulation of a virtual object in a virtual reality or augmented reality environment, a mass restriction device restricts or stops movement of the mass and confines the mass to one chamber of the at least two (2) chambers, thereby redistributing the mass within the hand-held device. The redistribution of mass within the hand-held device effects a change in the center of gravity of the hand-held device and a change in the moment of inertia of the hand-held device. The redistribution of mass can be controlled to simulate a desired haptic feedback corresponding to manipulation of a virtual object.

In embodiments of the present invention described herein, gravity is utilized to move a fluidic mass within an elongated housing of a hand-held device. Utilizing gravity to move the fluidic mass results in the hand-held device having fewer moving parts than a hand-held device that utilizes a motor or other actuator to move a mass. Accordingly, embodiments of the present invention are less expensive and easier to manufacture than a hand-held device that utilizes a motor to move a mass. Further, as compared to a hand-held device that utilizes a motor or other actuator to move a mass, the use of gravity to move the fluidic mass reduces the power requirements of the hand-held device, meaning the hand-held device can have a smaller power source, a longer-lasting power source, or a combination thereof.

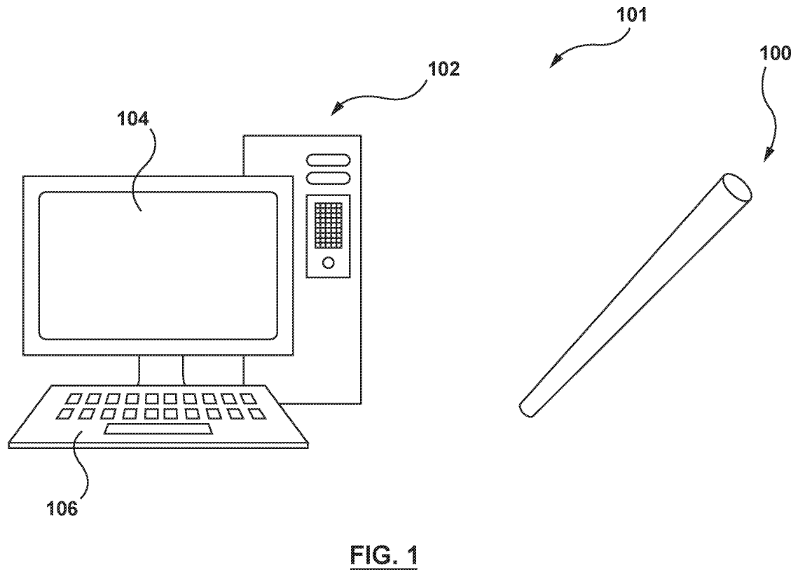

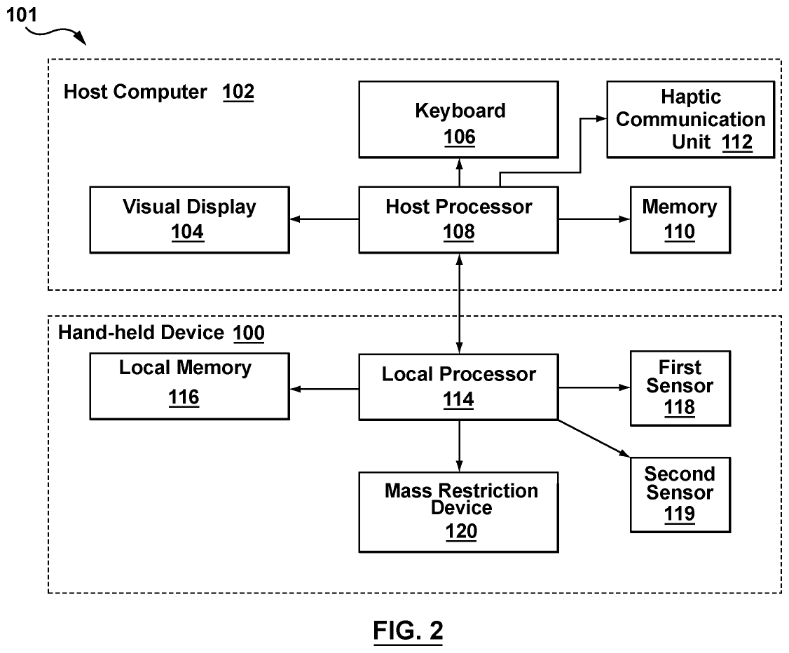

FIG. 1 is a schematic illustration of a system 101 including a hand-held device 100 for providing haptic feedback according to an embodiment hereof. The system 101 is for example, a virtual reality system, an augmented reality system, or a conventional display system. A user can hold and manipulate the hand-held device 100 to improve the immersive experience. The system 101 is configured to provide tactile feedback to the user, providing a perceived weight change to the hand-held device 100 to simulate manipulating a specific virtual object, as described below. The system 101 also includes a host computer 102 having a visual display 104 and a keyboard 106. FIG. 2 is a block diagram of the system of FIG. 1. The host computer 102 is configured to generate a virtual environment on the visual display 104. The host computer 102 preferably runs one or more host application programs with which a user is interacting via peripherals, such as but not limited to the keyboard 106 and the hand-held device 100. Although shown as a desktop computer in FIG. 1, the host computer 102 consistent with the present invention may be configured as a gaming console, a handheld gaming device, a laptop computer, a smartphone, a tablet computing device, a television, an interactive sign, and/or other device that can be programmed to provide a command signal.

As shown on the block diagram of FIG. 2, the host computer 102 also includes a host processor 108, a memory 110, a haptic communication unit 112, and/or other components. The host computer 102 may include, for example, a component for providing audio feedback to the user. The host processor 108 may be programmed by one or more computer program instructions to carry out methods described herein. More particularly, the host processor 108 may execute a software application that is stored in the memory 110 or another computer-readable or tangible medium. As used herein, for convenience, the various instructions may be described as performing an operation, when, in fact, the various instructions program the host processor 108 to perform the operation. In other embodiments, the functionality of the host processor 108 may be performed by hardware (e.g., through the use of an application specific integrated circuit (“ASIC”), a programmable gate array (“PGA”), a field programmable gate array (“FPGA”), etc.), or any combination of hardware and software. The host processor 108 may be any type of general purpose processor, or could be a processor specifically designed to provide haptic feedback signals. The host processor 108 may be the same processor that operates the host computer 102, or may be a separate processor. The host processor 108 can decide what haptic feedback to send to the hand-held device 100. The memory 110 may be any type of storage device or computer-readable medium, such as but not limited to random access memory (RAM), read only memory (ROM), flash memory, and/or any other memory suitable for storing software instructions. The memory 110 may store the computer program instructions (e.g., the aforementioned instructions) to be executed by the host processor 108 as well as data that may be manipulated by the host processor 108.

The host computer 102 is coupled to the visual display 104 via wired or wireless means. The visual display 104 may be any type of medium that provides graphical information to a user, including but not limited to monitors, television screens, plasmas, LCDs, projectors, or any other display devices. In an embodiment, the host computer 102 is a gaming device console and the visual display 104 is a monitor which is coupled to the gaming device console, as known in the art. In another embodiment, the host computer 102 and the visual display 104 may be combined into a single device. A user interacts with the visual display 104 by touching the keyboard 106 to activate, lift, move, or otherwise manipulate the virtual graphical objects displayed on the visual display 104 and thereby to provide inputs to the host computer 102. Further, as will be understood by one of ordinary skill in the art, alternative user input elements may be provided in addition to or as an alternative to the keyboard 106 to permit a user to interact with the visual display 104. The user input elements may include any elements suitable for accepting user input such as buttons, switches, dials, levers, touchscreens, and the like. The user input elements may further include peripherally connected devices, such as mice, joysticks, game controllers, keyboards, and the like. Movements of the user input elements may provide the host computer 102 with input corresponding to the movement of a computer generated graphical object, such as a cursor or other image, or some other graphical object displayed by the host computer 102 via the visual display 104, or to control a virtual character or gaming avatar, such as a person, vehicle, or some other entity that may be found in a game or computer simulation.

The haptic communication unit 112 of the host computer 102 may include any connection device, wired or wireless, that may transmit or communicate a command signal from the host processor 108 to a mass restriction device 120 associated with the hand-held device 100, which will be described in more detail below. In some implementations, the haptic communication unit 112 may be a dedicated unit configured solely for delivering a command signal. In some implementations, the haptic communication unit 112 may further function to deliver a myriad of other communications, wired or wirelessly, to another external device such as the keyboard 106, a hand-held controller (not shown), and/or other peripheral devices. In the embodiment shown in FIGS. 1 and 2, the haptic communication unit 112 is in communication with the hand-held device 100 using wireless communication means known to those of skill in the art. This can include but is not limited to BLUETOOTH® antennas, WI-FI® antennas, cellular antennas, infrared sensors, optical sensors, and any other device configured to receive and/or transmit information wirelessly. Further, the host computer 102 may be in the cloud and thus is not required to be wired or connected wirelessly in a local fashion. However, in other embodiments, the hand-held device 100 may communicate with the host computer 102 through wired communication ports, such as USB ports, HDMI® ports, A/V ports, optical cable ports, and any other component or device configured to receive or send information in a wired fashion.

As shown in the block diagram of FIG. 2, the hand-held device 100 may include a local processor 114, a local memory 116, the mass restriction device 120, a first sensor 118, and a second sensor 119. In operation, the local processor 114 is coupled to the mass restriction device 120 to provide command signals thereto based on high level supervisory or streaming commands from the host computer 102. For example, when in operation, magnitudes and durations are streamed from the host computer 102 to the hand-held device 100 where information is provided to the mass restriction device 120 via the local processor 114. The host computer 102 may provide high level commands to the local processor 114, whereby the local processor 114 instructs the mass restriction device 120. The local processor 114 may retrieve the characteristics of the haptic feedback from the local memory 116 coupled thereto. In addition, similar to the memory 110 of the host computer 102, the local memory 116 can be any type of storage device or computer-readable medium, such as but not limited to random access memory (RAM) or read-only memory (ROM). The local memory 116 may also be located internal to the local processor 114, or any combination of internal and external memory. Similar to the host processor 108, the local processor 114 also can decide what haptic feedback characteristics to send. Time critical processing is preferably handled by the local processor 114, and thus the local processor 114 is useful to convey closed-loop haptic feedback with high update rates (e.g., 5-10 kHz). In another embodiment hereof, the hand-held device 100 is configured to not include the local processor 114, whereby all input/output signals from the hand-held device 100 are handled and processed directly by the host computer 102.

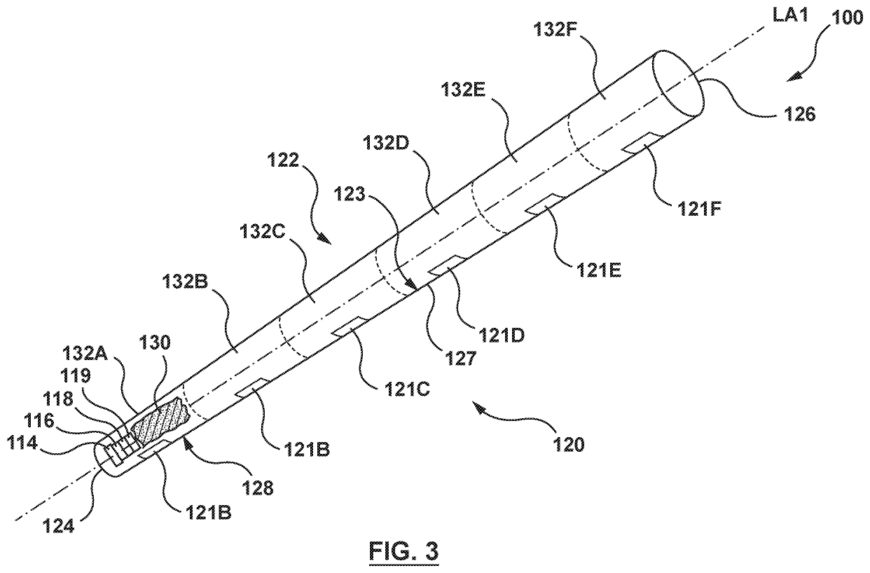

Turning to FIG. 3, the structure of the hand-held device 100 will now be described in more detail. The hand-held device 100 includes a hand-held elongated housing 122. As shown on FIG. 3, the elongated housing 122 includes a first end 124, a second end 126 opposite the first end 124, a handle portion 128, and six (6) integral sections or chambers 132A, 132B, 132C, 132D, 132E, and 132F (herein referred to collectively as chambers 132). The elongated housing 122 of the embodiment of FIG. 3 is a generally tubular structure including the first end 124, the second end 126, and the handle portion 128 disposed at or near the first end 124 of the elongated housing 122. The handle portion 128 may be configured to be gripped by a hand of a user. The elongated housing 122 is formed from any suitable material, including but not limited to plastics, composite materials, aluminum, carbon fiber, and rubber. While illustrated in FIG. 3 with a generally circular cross-section, this is by way of example and not limitation. The elongated housing 122 may have other cross sectional shapes including but not limited to an elliptical cross-section, a rectangular cross-section, a triangular cross-section, or any other suitable cross-sectional shape.

In the embodiment of FIG. 3, each chamber 132 is defined by a magnetic field of a corresponding electromagnet of the mass restriction device 120, as described in more detail below. Thus, in this embodiment, each chamber 132 is not structurally separated from the adjacent chambers 132, but the chambers 132 are described as distinct herein for sake of descriptive purposes only. Each chamber 132 is in fluid communication with the adjacent chamber(s) 132. While the embodiment of the elongated housing 122 shown in FIG. 3 includes six (6) chambers 132, this is by way of example and not limitation. In embodiments hereof, the elongated housing 122 includes at least two (2) chambers 132 but may include more than two (2) chambers.

The hand-held device 100 further includes a fluidic mass 130 slidably disposed within the elongated housing 122. In an embodiment, the fluidic mass 130 is initially held or contained within the handle portion 128, which is disposed at or near the first end 124 of the elongated housing 122 as described above. The handle portion 128 may be considered to be a reservoir as it initially contains the fluidic mass 130. The fluidic mass 130 is configured to move or slide within the chambers 132 of the elongated housing 122 in response to gravity, as described in more detail herein. In FIG. 3, the fluidic mass 130 is restricted or confined within the first chamber 132A by the mass restriction device 120, as described below. In the embodiment of FIGS. 1-5C, the fluidic mass 130 is a ferrofluid. As used herein, “ferrofluid” is meant to indicate a fluid or liquid that becomes strongly magnetized in the presence of a magnetic field. In an embodiment, the fluidic mass 130 includes nanoscale ferromagnetic or ferrimagnetic particles coated in a surfactant and suspended in a carrier fluid. In another embodiment, the fluidic mass 130 may be a plurality of non-nano ferrous particles suspended in a fluid or other ferrofluids.

Referring to FIGS. 2 and 3, the mass restriction device 120 is configured to receive a command signal from the host processor 108 and/or the local processor 114 that is indicative of a virtual interaction. In response to the command signal, the mass restriction device 120 is further configured to restrict or confine at least a portion of the fluidic mass 130 within one of the chambers 132. Mass redistribution and restriction of the fluidic mass 130 to a predetermined chamber 132 provides a change in a center of gravity and a change in a moment of inertia of the hand-held device 100. The change in the center of gravity and the change in the moment of inertia of the hand-held device 100 is perceived as a weight change in the hand-held device 100 to simulate either lifting or otherwise manipulating a virtual object.

In order to restrict or confine the fluidic mass 130 within at least one of the chambers 132, the mass restriction device 120 of the hand-held device 100 includes a plurality of electromagnets 121A, 121B, 121C, 121D, 121E, and 121F (herein referred to collectively as electromagnets 121). As used herein, the term “electromagnet” is used to indicate a type of magnet in which a magnetic field is produced by an electric current, and wherein the magnetic field disappears when the current is not present. Thus, each electromagnet 121 includes an unenergized state in which the electromagnet 121 does not present a magnetic field, and an energized state in which the electromagnet 121 presents a magnetic field. The magnetic field of each electromagnet 121 in the energized state defines the limits of the corresponding chamber 132. The axial limits of the chambers 132 are shown in FIG. 3 in phantom for illustrative purposes only. Accordingly, in the embodiment of FIG. 3, the first electromagnet 121A in the energized state defines the first chamber 132A, the second electromagnet 121B in the energized state defines the second chamber 132B, the third electromagnet 121C in the energized state defines the third chamber 132C, the fourth electromagnet 121D in the energized state defines the fourth chamber 132D, the fifth electromagnet 121E in the energized state defines the fifth chamber 132E, and the sixth electromagnet 121F in the energized state defines the sixth chamber 132F.

When an electromagnet 121 is in the unenergized state, the fluidic mass 130 is permitted to slide or move past the electromagnet 121 without restriction. However, when the fluidic mass 130 moves or slides near an electromagnet 121 in the energized state, the fluidic mass 130 is restricted or constrained by the electromagnetic force of the electromagnet 121 in the energized state. Stated another way, when the fluidic mass 130 is disposed adjacent to the electromagnet 121 in the energized state, the fluidic mass 130 is attracted to the electromagnet 121 in the energized state. The attraction of the fluidic mass 130 to the electromagnet 121 in the energized state restricts or confines the fluidic mass 130 to an area or corresponding chamber 132 adjacent the electromagnet 121 in the energized state.

When the mass restriction device 120 receives a command signal from the host processor 108 and/or the local processor 114 that is indicative of a virtual interaction, the mass restriction device 120 transitions at least one electromagnet 121 to the energized state. Each electromagnet 121 in the energized state generates a magnetic field, the strength of which is controlled by the mass restriction device 120. The fluidic mass 130 is attracted to the electromagnetic field or fields. Restriction of the fluidic mass 130 therefore depends upon both the strength of the magnetic field(s) and the proximity of the fluidic mass 130 to the magnetic field(s). At some point, the fluidic mass 130, or portions thereof are in close enough proximity to one or more of the magnetic field to restrict or confine the fluidic mass 130 or portions thereof within the axial boundaries or limits of the corresponding chamber or chambers 132. In an embodiment, the mass restriction device 120 controls the strength of the magnetic field of the electromagnets 121. For example, the strength of one or more electromagnets 121 can be controlled or varied such that only a portion of the fluidic mass 130 is attracted thereto. As another example, the strength of an electromagnet 121 can be controlled or varied such that the entire fluidic mass 130 is attracted thereto.

Restriction of the fluidic mass 130 to the corresponding chamber or chambers 132 changes a center of gravity and a moment of inertia of the hand-held device 100. The change in the center of gravity and the change in the moment of inertia of the hand-held device 100 is perceived as a weight change in the hand-held device 100 to simulate either lifting or otherwise manipulating a specific type of virtual object. In an embodiment, the mass restriction device 120 is configured to selectively activate one or more electromagnets 121 simultaneously. In an embodiment, the mass restriction device 120 may further be configured to selectively activate one or more electromagnets 121 in a sequence. In an embodiment, the mass restriction device 120 is configured to control the strength of electromagnetic field of each activated electromagnet 121. Accordingly, the mass restriction device 120 can restrict the fluidic mass 130 to one or more corresponding chambers 132. Additionally, the strength of the electromagnetic field of each activated electromagnet 121 can be selected to further restrict the fluidic mass 130 to a specific portion of the corresponding chamber or chambers 132, as described in more detail below. Thus, the mass restriction device 120 can selectively restrict the fluidic mass 130 to any portion of any chamber or chambers 132, in any combination to simulate a variety of virtual objects.

While each electromagnet 121 in FIG. 3 is illustrated as a flat element disposed on one side of the housing, this is by way of example and not limitation. Each electromagnet 121 can be of an alternative shape and disposed at an alternative location. For example, and not by way of limitation each electromagnet 121 can be an annular electromagnet extending around a full or entire circumference of the elongated housing 122 or can be an electromagnet that extends around only a portion of the circumference of the elongated housing 122. Alternatively, each electromagnet 121 can be a plurality of electromagnets. Further, each electromagnet 121 can be a plurality of electromagnets 121 collectively extending around a circumference of the elongated housing 122, and separately controllable so that the fluidic mass 130 can be selectively attracted to only one side or portion of the elongated housing 122, as described in more detail below.

The first sensor 118 is configured to sense an orientation of the elongated housing 122, and is further configured to communicate the orientation information to the local processor 114, or alternatively to the host processor 108. The local processor 114, or alternatively the host processor 108 utilize the orientation information from the first sensor 118 to determine an appropriate haptic feedback for a desired weight effect request, and to send a command signal to generate the appropriate haptic feedback. More precisely, the orientation information from the first sensor 118 is utilized by the local processor 114 or the host processor 108 to send a command signal to the mass restriction device 120. The command signal may direct the mass restriction device 120 to release the fluidic mass 130 from one of the chambers 132 and also to restrict or hold the fluidic mass 130 within a different chamber 132 to generate a predetermined perceived weight change of the hand-held device 100 in response to manipulation of a virtual object. In the embodiment of FIG. 3, the first sensor 118 is disposed within and coupled to the elongated housing 122. Examples of the first sensor 118 that may be coupled to the elongated housing 122 include accelerometers, gyroscopes, geomagnetic sensors, capacitive sensors, resistive sensors, surface acoustic wave sensors, optical sensors (e.g., an array of light sensors for a shadow-based sensor that detects position by measuring ambient-light shadows produced by external objects), force sensors (e.g., resistive sensors that measure or sense an amount of the mass resting against the sensor wherein the resistance of the sensor changes proportionally to the force applied thereto), or other suitable sensors.

The second sensor 119 is a position sensor. The second sensor 119 is configured to sense the position of the fluidic mass 130 within the elongated housing 122, and is further configured to communicate the position information to the local processor 114, or alternatively to the host processor 108. The local processor 114, or alternatively the host processor 108 utilize the position information from the second sensor 119 to determine an appropriate haptic feedback for a desired weight effect request and generate a corresponding command signal. More specifically, the position information from the second sensor 119 is utilized by the local processor 114 or the host processor 108 to send a command signal to the mass restriction device 120 to restrict the fluidic mass 130 within a predetermined chamber 132 to generate a predetermined perceived weight change of the hand-held device 100 in response to manipulation of a virtual object. In the embodiment of FIG. 3, the second sensor 119 is disposed within and coupled to the elongated housing 122. Examples of the second sensor 119 include electrical field sensors, proximity sensors, infrared reflection sensors, sonic sensors, magnetic sensors, or other suitable sensors.

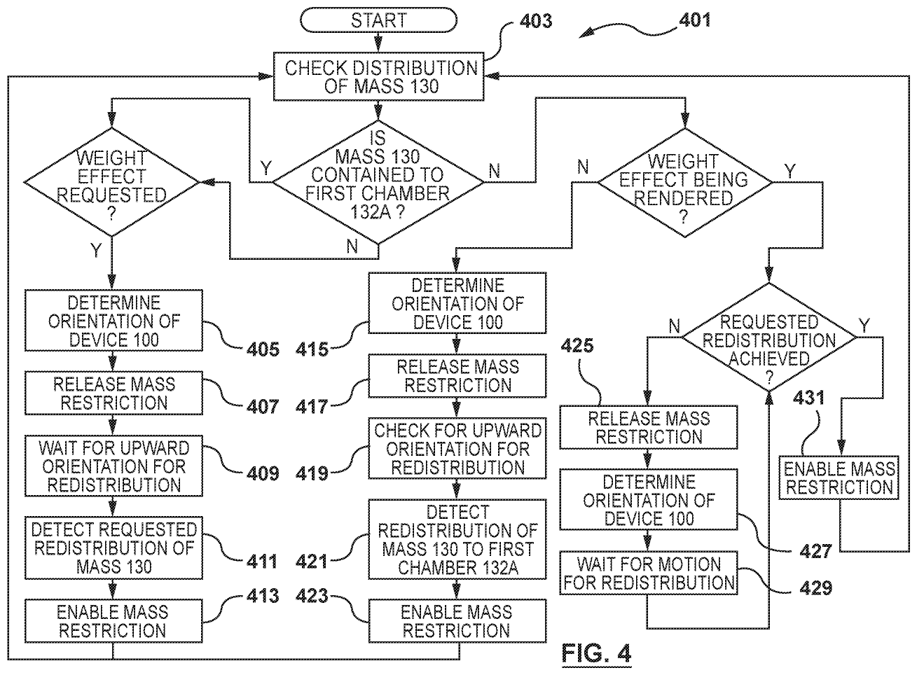

FIG. 4 is a flow chart depicting a process 401 for providing a haptic feedback indicative of a virtual interaction related to manipulating a virtual object with a hand-held device in accordance with an embodiment hereof. For instance, the hand-held device 100, via the mass restriction device 120, is configured to provide tactile feedback to a user by providing a perceived weight change of the hand-held device 100 to simulate lifting or manipulating a virtual object. When simulating lifting or manipulating a virtual object, the fluidic mass 130 moves within the elongated housing 122 by gravity, and the mass restriction device 120, or more specifically at least one electromagnet 121 of the mass restriction device 120, is configured to restrict the fluidic mass 130 within at least one (1) corresponding chamber 132 to change the center of gravity and the moment of inertia of the hand-held device 100. The change in the center of gravity and the moment of inertia create a perceived weight change in the hand of the user to simulate either lifting or otherwise manipulating a specific type of virtual object. The mass restriction device 120 triggers at least one electromagnet 121 in response to at least one user input interaction in a simulated environment, such as a virtual reality environment or an augmented reality environment. More particularly, the host processor 108 of the host computer 102 and/or the local processor 114 of the hand-held device 100 is configured to output a command signal to the mass restriction device 120 in response to at least one user input interaction and/or orientation information from the first sensor 118 and/or position information from the second sensor 119. The mass restriction device 120 can include circuitry that receives signals from the host processor 108 and/or the local processor 114 of the hand-held device 100 and energizes or deenergizes the electromagnets 121. The mass restriction device 120 may also include any circuitry required to convert the command signal from the processor(s) to an appropriate signal for use with the mass restriction device 120. Each electromagnet 121 in the energized state restricts the fluidic mass 130 to a corresponding chamber 132 of the elongated housing 122 to change the center of gravity and the moment of inertia of the hand-held device 100 in response to the command signal to provide haptic feedback to a user of the hand-held device 100. Such haptic feedback allows for a more intuitive, engaging, and natural experience for the user of the hand-held device 100.

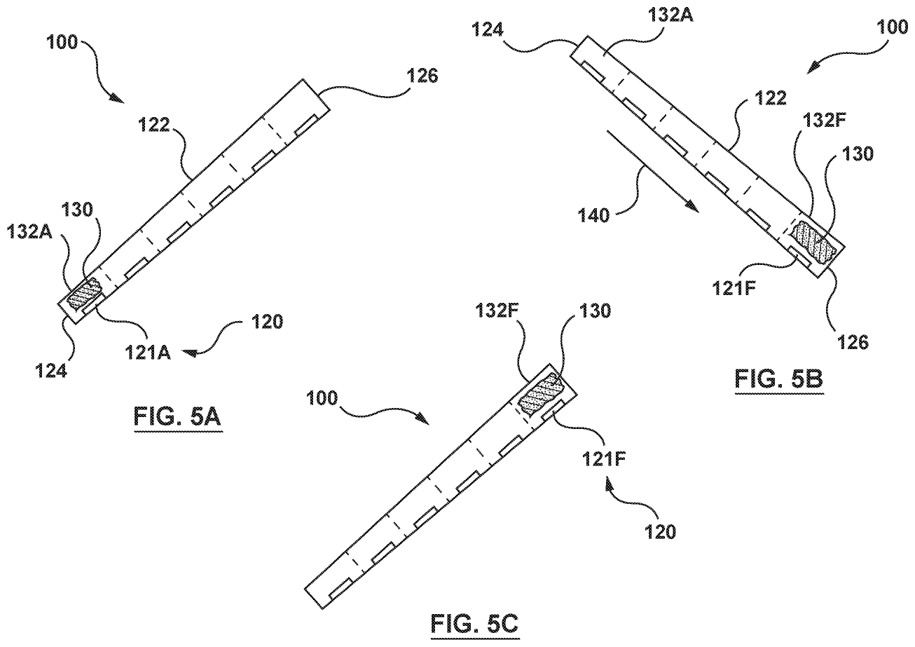

The interaction of the components of the hand-held device 100 to provide a haptic feedback to a user to simulate a change in weight of the hand-held device 100 as the user lifts or manipulates a virtual object will now be described with respect and FIGS. 5A-5C and the steps of the flow chart of FIG. 4. In each of FIGS. 5A-5C the local processor 114, the local memory 116, the first sensor 118, and the second sensor 119 has been omitted for clarity. FIG. 5A illustrates the hand-held device 100 held by a user in an orientation with the fluidic mass 130 positioned to simulate that no virtual object is in the hand of the user. More specifically, the elongated housing 122 is oriented with the first end 124 lower than or closer to the ground than the second end 126, and the fluidic mass 130 disposed within the first chamber 132A and restricted therein by the first electromagnet 121A in the energized state of the mass restriction device 120. The orientation information is sensed by the first sensor 118, while the position information (of the fluidic mass 130 within the elongated housing 122) is sensed by the second sensor 119. In an alternative embodiment, the mass restriction device 120 does not include the first electromagnet 121A and the fluidic mass 130 is disposed at the first end 124 of the elongated housing 122 only by gravity.

In the current example, the user desires to pick up a virtual object such as a virtual battle axe. The host processor 108 and/or the local processor 114 utilize information from the memory 110 and/or the local memory 116, respectively, to determine which chamber 132 the fluidic mass 130 needs to be restricted within to simulate the virtual battle axe. In this example, for a virtual battle axe the host processor 108 and/or the local processor 114 determine that the fluidic mass 130 needs to be restricted within the sixth chamber 132F. Additionally, the host processor 108 and/or the local processor 114 utilize information from the second sensor 119 to determine the current location or position of the fluidic mass 130, as depicted in step 403 of FIG. 4. In the present example, the fluidic mass 130 is initially disposed and restrained within the first chamber 132A, as shown in FIG. 5A.

With a weight effect requested (e.g., the user's desire to pick up the virtual battle axe), the host processor 108 and/or the local processor 114 utilize information from the first sensor 118 to determine the orientation of the elongated housing 122 in a step 405. Next, the host processor 108 and/or the local processor 114 send the command signal to the mass restriction device 120, and the mass restriction device 120 transitions the first electromagnet 121A to the unenergized state to release or remove the restriction to the fluidic mass 130, as shown in step 407 of FIG. 4.

The user manipulates the hand-held device 100 to place the second end 126 lower than, or closer to the ground than the first end 124, as shown in FIG. 5B and step 409 of FIG. 4. Once the second end 126 of the elongated housing is positioned below the first end 124, the fluidic mass 130 moves in a direction indicated by an arrow 140 towards the second end 126 due to gravity. The host processor 108 and/or the local processor 114 next utilize information from the second sensor 119 to determine when the fluidic mass 130 is within the predetermined sixth chamber 132F, as shown in step 411.

When the fluidic mass 130 is disposed within the sixth chamber 132F, the host processor 108 and/or the local processor 114 send the command signal to the mass restriction device 120, and the mass restriction device 120 transitions the sixth electromagnet 121F to the energized state, thereby restricting or retaining the fluidic mass 130 within the sixth chamber 132F, as shown in FIG. 5B and in step 413 of FIG. 4.

Movement of the fluidic mass 130 from the first chamber 132A to the sixth chamber 132F changes the center of gravity of the hand-held device 100, moving the center of gravity towards the second end 126 of the elongated housing 122. Further, movement of the fluidic mass 130 from the first chamber 132A to the sixth chamber 132F changes the moment of inertia of the hand-held device 100. The change in the center of gravity towards the second end 126 of the elongated housing 122 and the change in the moment of inertia of the hand-held device 100 are perceived by the user as an increase in weight of the hand-held device 100 as the user lifts or otherwise manipulates the virtual battle axe.

When the fluidic mass 130 is disposed within the sixth chamber 132F and restricted therein by the sixth electromagnet 121F in the energized state, the user can manipulate the hand-held device 100 as desired without movement of the fluidic mass 130 between the chambers 132. The hand-held device 100 provides continuous tactile feedback (i.e. perceived weight of the virtual battle axe) to the user manipulating the virtual battle axe, as shown in FIG. 5C.

The interaction of the components of the hand-held device 100 have been described herein with the fluidic mass 130 initially disposed within the first chamber 132A of the elongated housing 122. Accordingly, the step 403 and the steps 405-413 of FIG. 4 have been utilized to provide haptic feedback to the user. However, when the fluidic mass 130 is initially disposed at a location other than the first chamber 132A, alternative steps of FIG. 4 can be utilized to provide haptic feedback to the user. For example, to release the virtual battle axe, the step 403 and the steps 415-423 are utilized to redistribute the fluidic mass 130 from the sixth chamber 132F to the first chamber 132A. The changes to the center of gravity and the center of inertia of the hand-held device 100 when the fluidic mass 130 is redistributed from the sixth chamber 132F to the first chamber 132A are perceived by the user as a decrease in weight as the user virtually drops or releases the virtual battle axe. Alternatively, when the fluidic mass 130 is not disposed within the first chamber 132A and a weight effect is being rendered, the step 403 and the steps 425-429 or the step 431 of FIG. 4 can be utilized to provide haptic feedback to the user.

Although the electromagnets 121 in the embodiment of FIG. 3 are longitudinally aligned and disposed along an inner surface 123 of a first side 127 of the elongated housing, this too is by way of example and not limitation. Alternatively, each electromagnet 121 can be disposed at other locations of the elongated housing 122.

For example, in an embodiment illustrated in FIG. 5D, a hand-held device 500 includes an elongated housing 522, a mass restriction device 520 including a plurality of electromagnets 521A, 521B, 521C, 521D, 521E, 521F, 521G, 521H, 521I, 521J, 521K, and 521L (herein referred to collectively as electromagnets 521) and a fluidic mass 530. The hand-held device 500, the elongated housing 522, the mass restriction device 520, the plurality of electromagnets 521, and the fluidic mass 530 are similar to the hand-held device 100, the elongated housing 122, the mass restriction device 120, the plurality of electromagnets 121, and the fluidic mass 130 previously described with respect to FIGS. 1-5C. Therefore, similar details of the similar components and alternatives of the hand-held device 500 will not be repeated. However, in the embodiment of the hand-held device 500, the plurality of electromagnets 521 of the mass restriction device 520 are disposed in an alternate and non-uniform configuration.

As illustrated in FIG. 5D, a first electromagnet 521A of the plurality of electromagnets is disposed on an inner surface 523 on a first side 527 of the elongated housing 522. The first electromagnet 521A is configured to define a first chamber 532A when the first electromagnet 521A is in the energized state. A second electromagnet 521B of the plurality of electromagnets is disposed on an outer surface 525 of the first side 527 of the elongated housing 522. A third electromagnet 521C of the plurality of electromagnets is disposed on the outer surface 525 of a second side 529 of the elongated housing 522. Each of the second and third electromagnets 521B, 521C are axially displaced a first distance D1 from the first electromagnet 521A. The second and the third electromagnets 521B, 521C are collectively configured to define the second chamber 532B when the second and/or the third electromagnet 521B, 521C is in the energized state. A fourth electromagnet 521D of the plurality of electromagnets is disposed within a wall 531 of the elongated housing the first side 527, and a fifth electromagnet 521E of the plurality of electromagnets is disposed opposite the fourth electromagnet 521D and within the wall 531 on the second side 529 of the elongated housing 522. Each of the fourth and fifth electromagnets 521D, 521E is axially displaced a second distance D2 from the second electromagnet 521B. The fourth and the fifth electromagnets 521D, 521E are collectively configured to define a third chamber 532C when the fourth and/or the fifth electromagnet 521D, 521E is in the energized state. A sixth electromagnet 521F of the plurality of electromagnets is disposed on the inner surface 523 of the first side 527 of the elongated housing 522. The sixth electromagnet 521F is axially displaced from the fourth electromagnet 521D by a third distance D3. A seventh and an eighth electromagnet 521G, 521H, respectively, are each disposed on the inner surface 523 of the second side 529 of the elongated housing 522. The seventh and the eighth electromagnets 521G, 521H are axially displaced from each other by a fourth distance D4, and further are each axially displaced from the sixth electromagnet 521F a fifth distance D5 and a sixth distance D6, respectively. The sixth, seventh, and eighth electromagnets are collectively configured to define the fourth chamber 532D when the sixth, seventh, and/or eighth electromagnet is in the energized state. A ninth electromagnet 521I of the plurality of electromagnets is disposed on the inner surface 523 of the first side 527 of the elongated housing 522. A tenth electromagnet 521J of the plurality of electromagnets is disposed opposite the ninth electromagnet 521I and on the inner surface 523 of the second side 529 of the elongated housing 522. Each of the ninth and the tenth electromagnets 521I, 521J is axially displaced a seventh distance D7 from the sixth electromagnet 521F. The ninth and the tenth electromagnets 521I, 521J are collectively configured to define a fifth chamber 532E when the ninth and/or the tenth electromagnets 521I, 521J is in the energized state. An eleventh electromagnet 521K of the plurality of electromagnets is disposed on the inner surface 523 of the first side 527 of the elongated housing 522. A twelfth electromagnet 521L of the plurality of electromagnets is disposed opposite the eleventh electromagnet 521K and on the inner surface 523 of the second side 529 of the elongated housing 522. Each of the eleventh and the twelfth electromagnets 521K, 521L are axially displaced an eighth distance D8 from the ninth electromagnet 521I. The eleventh and the twelfth electromagnets 521K, 521L are collectively configured to define a sixth chamber 532F when the eleventh and/or the twelfth electromagnets 521K, 521L is in the energized state.

In the embodiment of FIG. 5D, the first distance D1, the second distance D2, the third distance D3, the fourth distance D4, and the fifth distance D5, the sixth distance D6, the seventh distance D7, and the eighth distance D8 can each be the same or an equivalent distance, can each be a different or nonequivalent distance or can include a combination of equivalent and nonequivalent distances. The disposition of the electromagnets 521 at different locations of the elongated housing 522 illustrates that the placement of each electromagnet 521 can be combined in any combination. The mass restriction device 520 is configured to selectively transition or activate one or more of the electromagnets 521 to the energized state to effect a desired change in the center of gravity and the moment of inertia of the hand-held device 500 to elicit a perceived weight change to simulate any number of virtual objects. Stated another way, the electromagnets 521 may be selectively activated by the mass restriction device 520 to change the distribution of the fluidic mass 530 within the chamber or chambers 532.

For example, in the embodiment of FIG. 5D, the second, the fourth, the sixth, the ninth, and the eleventh electromagnets 521B, 521D, 521F, 521I, 521K, respectively, can be simultaneously or sequentially transitioned to the energized state by the mass restriction device 520. Additionally, the strength of the magnetic field of each of the electromagnets 521 in the energized state can be controlled by the mass restriction device 520 such that the fluidic mass 530 is disposed within the second, the third, the fourth, the fifth, and/or the sixth chambers 532B, 532C, 532D, 532E, 532F to radially restrict the fluidic mass 530, for example, radially between the longitudinal axis LA1 and the first side 527 to simulate a virtual object such as a sword.

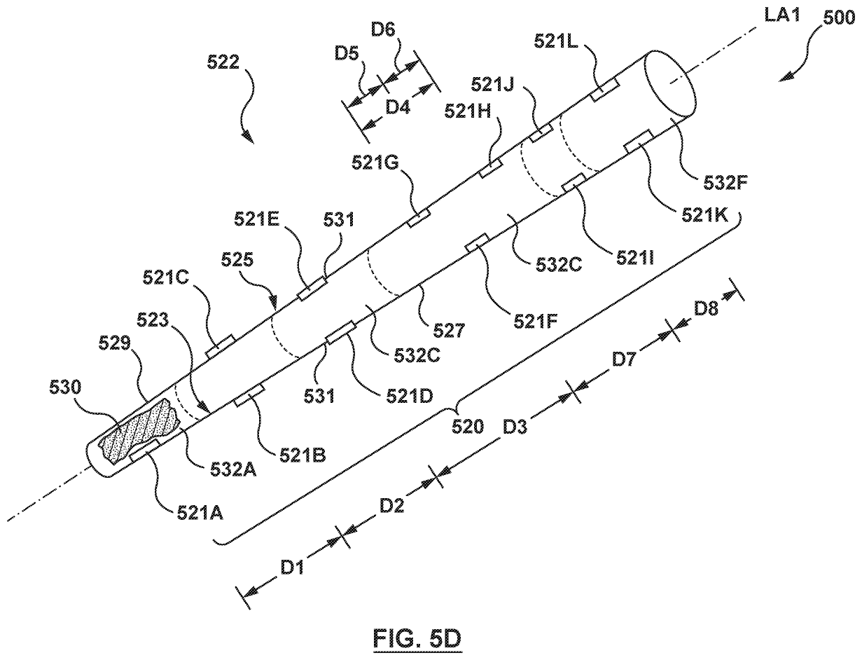

FIG. 6 is a schematic illustration of a system including a hand-held device 600 for providing haptic feedback according to an embodiment hereof, wherein the system also includes a host computer 602 having a visual display 604, a keyboard 606, a host processor 608, memory 610, and haptic communication unit 612. The host computer 602, the visual display 604, the keyboard 606, the host processor 608, the memory 610, and the haptic communication unit 612 are similar to the host computer 102, the visual display 104, the keyboard 106, the host processor 108, the memory 110, and the haptic communication unit 112 previously described with respect to FIGS. 1-5C. Therefore, details of the host computer 602, the visual display 604, the keyboard 606, the host processor 608, the memory 610, and the haptic communication unit 612 will not be repeated with respect to the embodiment of FIGS. 6-8C.

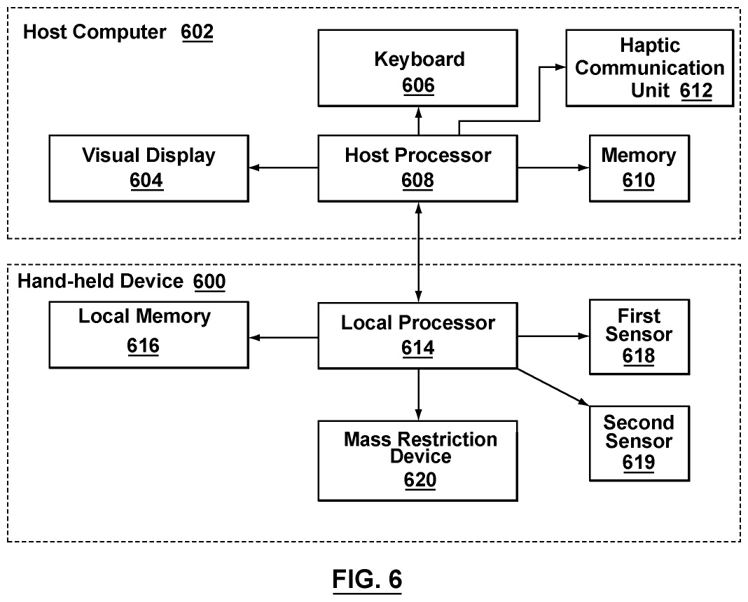

FIG. 7 illustrates the structure of the hand-held device 600. The hand-held device 600 includes a local processor 614, a local memory 616, a first sensor 618, a second sensor 619, an elongated housing 622, and a mass restriction device 620. The local processor 614, the local memory 616, the first sensor 618, and the second sensor 619 are similar to the local processor 114, the local memory 116, the first sensor 118, and the second sensor 119 previously described. Therefore, details of the local processor 614, the local memory 616, the first sensor 618, and the second sensor 619 are not repeated here.

The elongated housing 622 of the hand-held device 600 includes a first end 624, a second end 626 opposite the first end 624, a handle portion 628, and four (4) chambers 632A, 632B, 632C, and 632D (herein referred to collectively as chambers 632). Each chamber 632 is configured to receive a fluidic mass 630 therein. The elongated housing 622 is a generally tubular structure with the handle portion 628 configured to be gripped by a hand of a user. The elongated housing 622 is formed from any suitable material, including but not limited to plastics, composite materials, and aluminum. While illustrated in FIG. 7 with a generally circular cross-section, this is by way of example and not limitation. The elongated housing 622 may have other cross sectional shapes including but not limited to an elliptical cross-section, a rectangular cross-section, a triangular cross-section, or any other suitable cross-sectional shape. Although FIG. 7 shows four (4) chambers 632 within the elongated housing 622, this too is by way of example and not limitation. In other embodiments, the elongated housing 622 may include a greater or lesser number of chambers 632.

The fluidic mass 630 is slidably disposed within the chambers 632 of the elongated housing 622 and is configured to move between the chambers 632 by gravity. In FIG. 7, the fluidic mass 630 is slidably disposed and restricted within the first chamber 632A. The fluidic mass 630 is any fluid suitable for use within the hand-held device 600, non-limiting examples of which include water or saline. In another embodiment, the fluidic mass can be formed of solid particles suspended in a fluid. For example, the solid particles in a fluid suspension may be sand particles or a plurality of small spheres suspended in a fluid.

The mass restriction device 620 of the hand-held device 100 includes three (3) valves 633A, 633B, and 633C (herein referred to collectively as valves 633). Each valve 633 is disposed between two (2) adjacent chambers 632. Thus, the first valve 633A is disposed between the first chamber 632A and the second chamber 632B, the second valve 633B is disposed between the second chamber 632B and the third chamber 632C, and the third valve 633C is disposed between the third chamber 632C and the fourth chamber 632D. Each valve 633 includes an open state wherein the valve 633 is configured to permit fluid communication between the chambers 632 adjacent the valve 633, and a closed state configured to prevent fluid communication between the chambers 632 adjacent the valve 633. The mass restriction device 620 is configured to receive a command signal from the host processor 608 and/or the local processor 614 that is indicative of a virtual interaction. In response to the command signal, the mass restriction device 620 actuates one or more valves 633 to restrict the fluidic mass 630 within at least one predetermined chamber 632. Restriction of the fluidic mass 630 to at least one predetermined chamber 632 provides a change in a center of gravity and a change in a moment of inertia of the hand-held device 600, as described below. Each valve 633 can be of any configuration suitable for the purposes described herein. Examples of suitable valve configurations include, but are not limited to a control valve configured to control fluid flow by varying the size of a flow passage as directed by the command signal, a ball valve, a butterfly valve, a diaphragm valve, a gate valve, or other suitable valves. As will be described in more detail herein, distribution and restriction of the fluidic mass 630 to one or more chambers 632 can be achieved by various methods including, but not limited to controlling the size of an opening of each valve 633 in an open state, controlling the rate of which each valve 633 transitions to the closed state, controlling the sequence of the transition of each valve 633 to the closed state, or any other methods suitable for the purposes described herein.

In the embodiment of FIG. 7, each chamber 632 is radially defined by an inner surface 623 of the elongated housing 622. Each chamber 632 is axially defined by two (2) adjacent valves 633 of the mass restriction device 620, or an end of the elongated housing 622 and one valve 633 of the mass restriction device 620. Thus, in this embodiment, each chamber 632 is structurally separated from the adjacent chambers 632 via the valves 633 of the mass restriction device 620. While each valve 633 is shown disposed in a specific location within the elongated housing 622, and the chambers 632 are shown as approximately the same size or length, this is by way of example and not limitation. Each valve 633 may be disposed at any location within the elongated housing 622 suitable for the purposes described herein, and may be disposed to define chambers of different sizes or lengths.

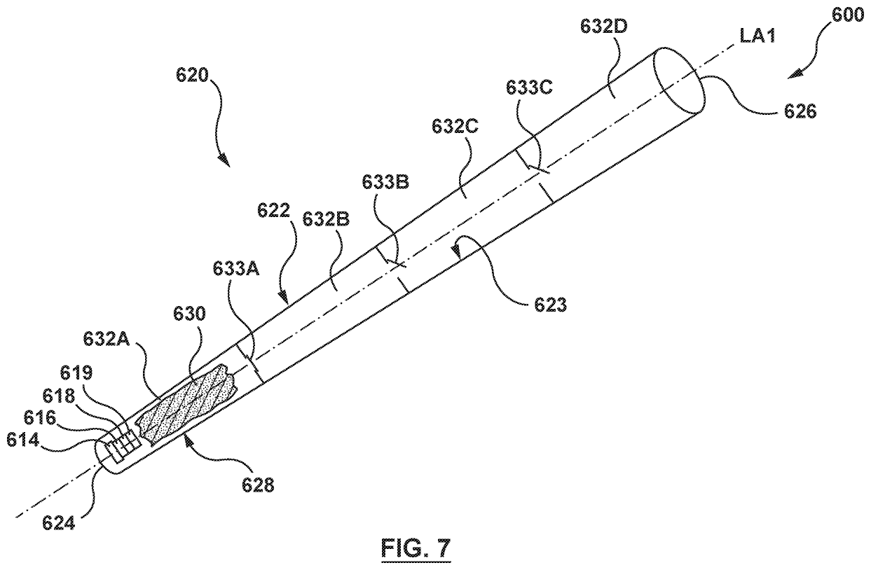

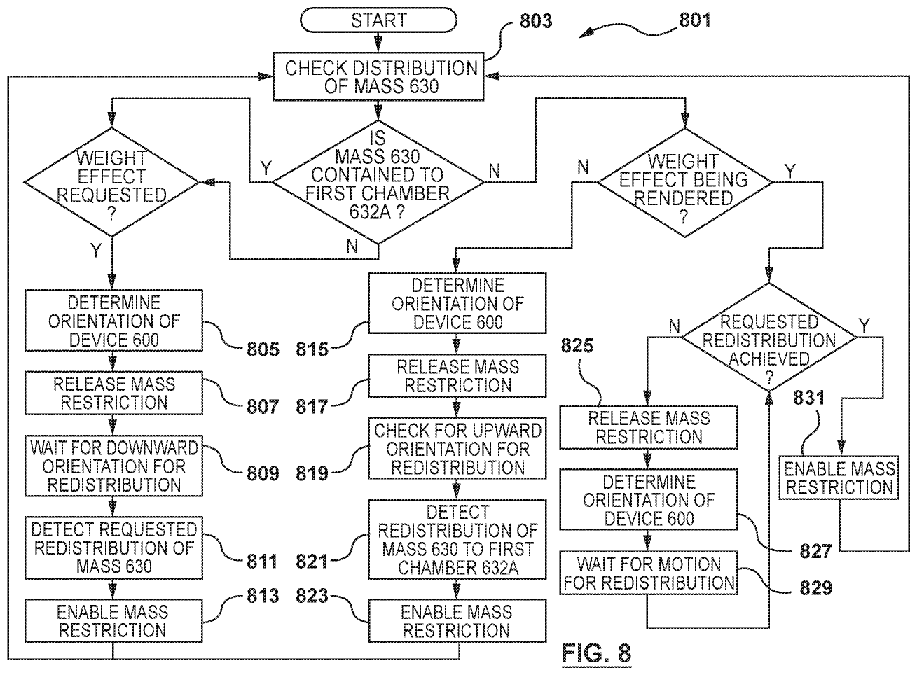

FIG. 8 is a flow chart depicting a process 801 for providing a haptic feedback indicative of a virtual interaction related to manipulating a virtual object with the hand-held device 600 in accordance herewith. FIG. 8 and FIGS. 9A-9C will be referenced to describe the interaction of the components of the hand-held device 600 to provide a haptic feedback to a user to simulate a change in weight of the hand-held device 600 as the user lifts or manipulates a virtual object. In each of FIGS. 9A-9C the local processor 614, local memory 616, the first sensor 618, and the second sensor 619 has been omitted for clarity. FIG. 9A illustrates the hand-held device 600 held by a user in an orientation and with the fluidic mass 630 positioned within the first chamber 632A to simulate that no virtual object is in the hand of the user. In the example described with respect to FIGS. 9A-9C, the fluidic mass 630 is restricted to the first chamber 632A by the first valve 633A in the closed state as shown in FIG. 9A.

In the example, the user desires to pick up a virtual club. The host processor 608 and/or the local processor 614 utilize information in the memory 610 and/or the local memory 616 to determine which chamber 632 the fluidic mass 630 needs to be restricted within to simulate the perceived weight effects of the virtual club. In this example, the third chamber 632C is determined to be the predetermined chamber 632 for the fluidic mass 630 to simulate the virtual club. The host processor 608 and/or the local processor 616 utilize information from the second sensor 619 to locate the fluidic mass 630 in the first chamber 632A of the elongated housing 622, as depicted in step 803 of FIG. 8.

With a weight effect requested (e.g., the user's desire to pick up a virtual club), the host processor 608 and/or the local processor 614 utilize information from the first sensor 618 to determine the orientation of the elongated housing 622 in a step 805. Next, the host processor 608 and/or the local processor 614 send the command signal to the mass restriction device 620, and the mass restriction device 620 activates or transitions the first valve 633A to the open state to remove the restriction to the fluidic mass 630, as shown in step 807. The second valve 633B and the third valve 633C may also be transitioned to the open state, depending on the desired target location of the fluidic mass 630.

In FIG. 9B, the user manipulates the hand-held device 600 to place the second end 626 lower than, or closer to the ground than the first end 624, as shown in step 809 of FIG. 8. Once the second end 826 of the elongated housing is positioned below the first end 624, the fluidic mass 630 moves in a direction indicated by an arrow 640 towards the second end 626 by gravity. The host processor 608 and/or the local processor 614 utilize information from the second sensor 619 to determine when the fluidic mass 630 is within the predetermined third chamber 632C, as shown in step 811.

When the fluidic mass 630 is disposed within the third chamber 632C, the host processor 608 and/or the local processor 614 send the command signal to the mass restriction device 620, and the mass restriction device 620 activates or transitions at least the second valve 633B and the third valve 633C to the closed state to restrict or confine the fluidic mass 630 within the third chamber 632C, as shown in FIG. 9C and in step 813 of FIG. 8. The first valve 633A may also be transitioned to the closed state. In this embodiment, the movement of the fluidic mass 630 from the first chamber 632A to the third chamber 632C changes the center of gravity and the moment of inertia of the hand-held device 600. The changes in the center of gravity and the moment of inertia of the hand-held device 600 are perceived by the user as an increase in weight of the hand-held device 600. The perceived change in weight simulates the virtual club as the user lifts or otherwise manipulates the hand-held device 600. When the fluidic mass 630 is disposed within the third chamber 632C and restricted therein by the second and third valves 633B, 633C each in the closed state, the user can manipulate the hand-held device 600 as desired and the hand-held device 600 provides tactile feedback to simulate the user manipulating the virtual club, as shown in FIG. 9C.

To release the virtual battle club, the step 803 and the steps 815-823 are utilized to redistribute the mass 630 from the third chamber 632C to the first chamber 632A. The changes in the center of gravity and center of inertia are perceived by the user as a decrease in weight to simulate the user dropping or releasing the virtual club. Alternative steps of FIG. 8 can be performed when the fluidic mass 630 is not disposed within the first chamber 632A and a weight effect is being rendered. For example, when the fluidic mass 630 is not contained within the first chamber 632A, and a weight effect is being rendered, the steps 825-829 can be performed when the desired mass redistribution has not yet been achieved, or step 831 can be performed when the requested mass redistribution has been achieved.

While the embodiment of FIGS. 6-9C has been described with the fluidic mass 630 restricted to only one (1) chamber 632 to elicit a perceived weight change, this is by way of example and not limitation. In an alternative embodiment, the fluidic mass 630 can be restricted within more than one (1) chamber to elicit a desired perceived weight change. Restriction of the fluidic mass 630 to more than one (1) chamber can be achieved by methods such as, but not limited to controlling the size and/or shape of an opening of each of the valves 633 in the open state.

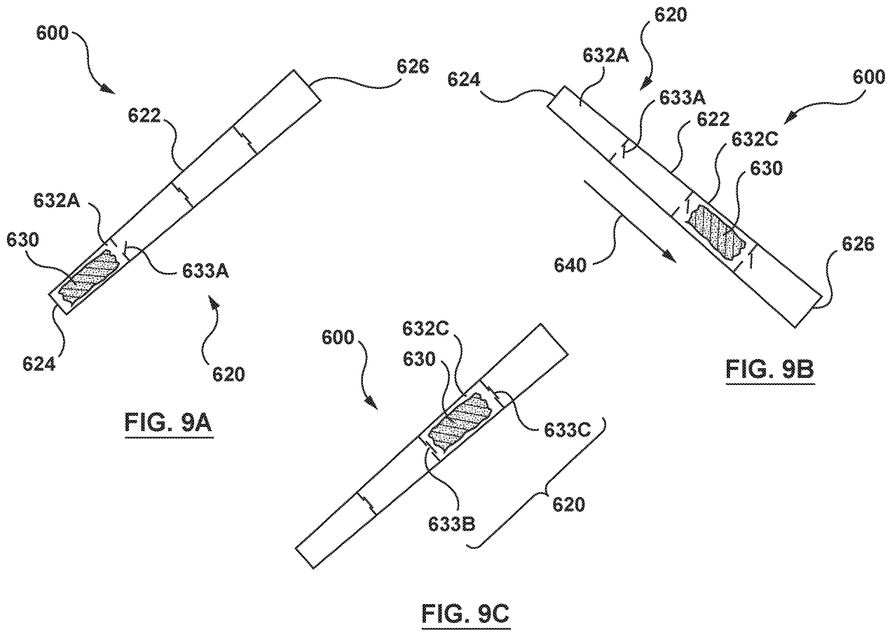

In another embodiment hereof illustrated in FIGS. 10A and 10B, a hand-held device 1000 includes an elongated housing 1022 including a plurality of chambers 1032A, 1032B, 1032C, and 1032D (herein referred to collectively as chambers 1032). The hand-held device 1000 further includes a fluidic mass 1030 and a mass restriction device 1020. The mass restriction device 1020 includes a plurality of valves 1033A, 1033B, and 1033C (herein referred to collectively as valves 1033). The hand-held device 1000 is similar to the hand-held device 600 previously described with respect to FIGS. 6-9C, except that the chambers 1032 are not formed concentric with a longitudinal axis LA1 of the elongated housing 1022, but rather eccentrically on one side of the elongated housing 1022. More particularly, in the embodiment of FIGS. 10A and 10B, the elongated housing 1022 includes a first chamber 1032A, a second chamber 1032B, a third chamber 1032C, and a fourth chamber 1032D. Each chamber 1032 is disposed on a first side 1027 of the elongated housing 1022, between an inner surface 1023 of the elongated housing 1022 and an internal wall 1041. The internal wall 1041 longitudinally divides the elongated housing 1022 along the longitudinal axis LA1 of the elongated housing 1022. Stated another way, the internal wall 1041 bisects the elongated housing 1022 to form the chambers 1032 on the first side 1027, and further to form an elongated void 1035 on a second side 1029 of the elongated housing 1022. While the embodiment of FIG. 10B shows the internal wall 1041 dividing the elongated housing 1022 into two (2) equal portions, this is by way of example and not limitation, and the internal wall 1041 can optionally divide the elongated housing 1022 into non-equal portions in any suitable ratio. For example, in an embodiment the internal wall 1041 can be disposed within the elongated housing 1022 such that the plurality of chambers 1032 cover 25%, 50%, or 75% of the internal volume of the elongated housing 1022, and the void 1035 encompasses 75%, 50%, or 25% of the internal volume of the elongated housing 1022, respectively. The embodiment described with respect to the FIGS. 10A and 10B permits the hand-held device 1000, and more specifically the mass restriction device 1020 to restrict or confine the fluidic mass 1030 eccentrically relative to the longitudinal axis LA1 of the hand-held device 1000, with the fluidic mass 1030 disposed within at least one of the chambers 1032 on the first side 1027 of the elongated housing 1022. Stated another way, the fluidic mass 1030 is disposed radially outward of the longitudinal axis LA1 and towards the first side 1027 of the elongated housing 1022 to simulate the weight effects or characteristics of a virtual object such as a virtual sword utilized by a user in a virtual reality or augmented reality system.

While FIGS. 10A and 10B show the elongated housing 1022 with four (4) chambers 1032, this is by way of example and not limitation. In embodiments hereof, the elongated housing 1022 of the hand-held device 1000 can include a greater or lesser number of chambers 1032. Further, while shown with the chambers 1032 disposed along the first side 1027, in alternative embodiments hereof, the chambers 1032 can be disposed on the second side 1029 opposite the first side 1027, on both the first and the second sides 1027,1029, or at any location suitable for the purposes described herein. Even further, while the chambers 1032 are shown in the cross-sectional view of FIG. 10B with a generally semi-circular cross-section, this too is by way of example and not limitation. The internal wall 1041 may have a variety of shapes such that the chambers 1032 may have a variety of alternative cross-sectional shapes including but not limited a crescent cross-sectional shape, a wedge cross-sectional shape or any other cross-sectional shape suitable for the purposes described herein.

The shape of each chamber 1032 of the hand-held device 1000 influences the weight distribution of the fluidic mass 1030. Accordingly, the shape of each chamber 1032 can be selected to produce, enhance, or otherwise optimize haptic feedback of the hand-held device 1000. While described herein with the internal wall 1035 defining the void 1035 and the chambers 1032, in another embodiment hereof, a sidewall of the second side 1029 of the elongated housing 1022 can be of increased thickness such that a percentage of the elongated housing 1022 is solid, rather than a void.

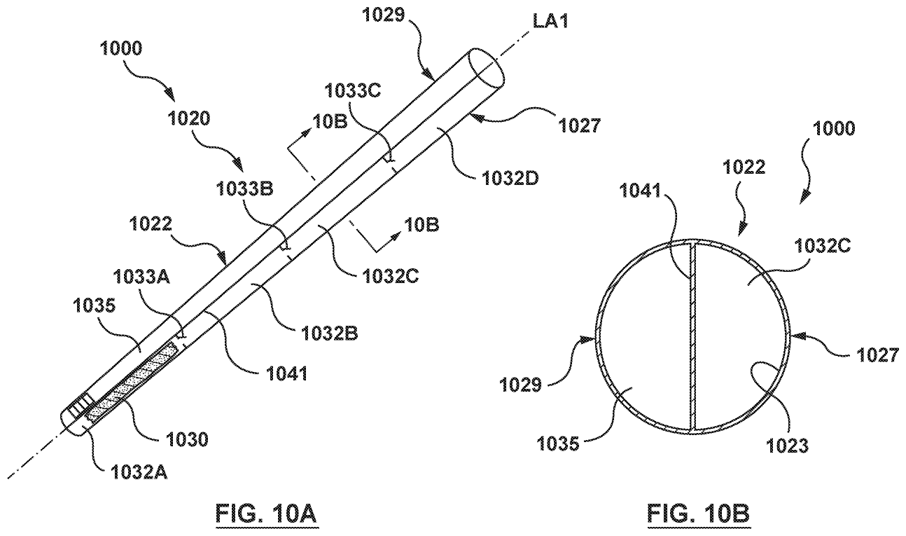

FIG. 11 is a schematic illustration of a system including a hand-held device 1100 for providing haptic feedback according to another embodiment hereof. The system further includes a host computer 1102 having a visual display 1104, a keyboard 1106, a host processor 1108, memory 1110, and haptic communication unit 1112. The host computer 1102, the visual display 1104, the keyboard 1106, the host processor 1108, the memory 1110, and the haptic communication unit 1112 are similar to the host computer 102, the visual display 104, the keyboard 106, the host processor 108, the memory 110, and the haptic communication unit 112 previously described with respect to FIGS. 1-5C. Therefore, details of the host computer 1102, the visual display 1104, the keyboard 1106, the host processor 1108, the memory 1110, and the haptic communication unit 1112 will not be repeated with respect to the embodiment of FIGS. 11-14C.

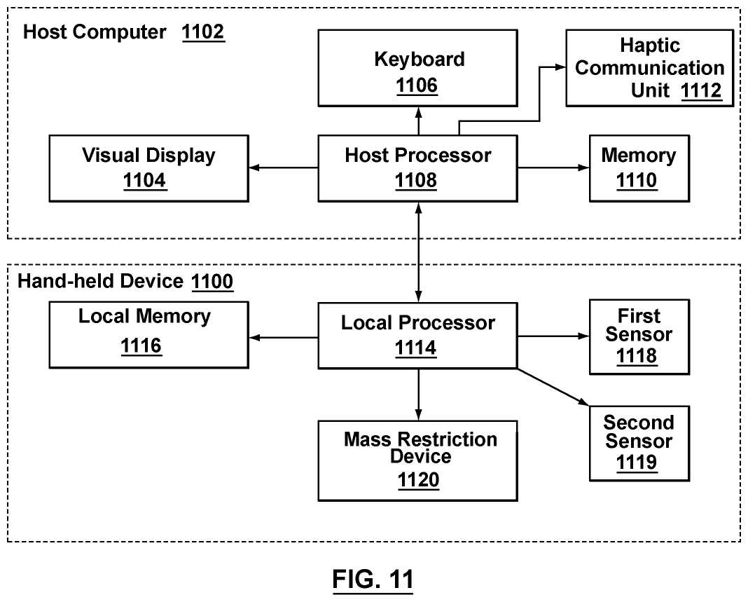

FIG. 12A illustrates the structure of the hand-held device 1100. The hand-held device 1100 includes a local processor 1114, a local memory 1116, a first sensor 1118, a second sensor 1119, and a mass restriction device 1120. The local processor 1114, the local memory 1116, the first sensor 1118, and the second sensor 1119 are similar to the local processor 114, the local memory 116, the first sensor 118, and the second sensor 119 previously described. Therefore, details of the local processor 1114, the local memory 1116, the first sensor 1118, and the second sensor 1119 are not repeated here. In the embodiment of FIGS. 11-14C, the hand-held device 1100 includes an elongated housing 1122 including a first end 1124, a second end 1126 opposite the first end 1124, a handle portion 1128, and three (3) chambers 1132A, 1132B, and 1132C (herein referred to collectively as chambers 1132). The fluidic mass 1130 is slidably disposed within the chambers 1132 of the elongated housing 1122, and is configured to move between the chambers 1132 in response to gravity. In FIG. 12A, the fluidic mass 1130 is slidably disposed within and restricted to the first chamber 1132A. The fluidic mass 1130 is similar to the fluidic mass 630 previously described.

The mass restriction device 1120 includes a first bladder valve 1137A and a second bladder valve 1137B (herein referred to collectively as bladder valves 1137). As best illustrated in FIG. 12A, the first bladder valve 1137A is disposed between the first chamber 1132A and the second chamber 1132B, and the second bladder valve 1137B is disposed between the second chamber 1132B and the third chamber 1132C. Each bladder valve 1137 is coupled to an inner surface 1123 of the elongated housing 1122. In this embodiment, each chamber 1132 is thus radially defined by the inner surface 1123 of the elongated housing 1122 and is axially defined by two (2) adjacent bladder valves 1137 of the mass restriction device 1120, or an end of the elongated housing 1122 and bladder valve 1137 of the mass restriction device 1120. Thus, in this embodiment, each chamber 1132 is structurally separated from the adjacent chambers 1132 via the bladder valves 1137 of the mass restriction device 1120. While each bladder valve 1137 is shown disposed in a specific location within the elongated housing 1122, and the chambers 1132 are shown as approximately the same size or length, this is by way of example and not limitation. Each bladder valve 1137 may be disposed at any location within the elongated housing 1122 suitable for the purposes described herein, and may be disposed to define chambers of different sizes or lengths.

The mass restriction device 1120 is configured to receive a command signal from the host processor 1108 and/or the local processor 1114 that is indicative of a virtual interaction. In response to the command signal, the mass restriction device 1120 actuates at least one of the bladder valves 1137 to restrict the fluidic mass 1130 within at least one predetermined chamber 1132. Restriction of the fluidic mass 1130 to at least one predetermined chamber 1132 provides a change in a center of gravity and a change in a moment of inertia of the hand-held device 1100. The change in the center of gravity and moment of inertia are perceived by a user as a change in weight of the hand-held device 1100. The perceived change in weight of the hand-held device 1100 simulates lifting or otherwise manipulating a specific virtual object as previously described with respect to embodiments described above.

Each bladder valve 1137 includes an open state when the bladder valve 1137 is configured to permit fluid communication between the chambers 1132 adjacent the bladder valve 1137 in the open state, and a closed state when the bladder valve 1137 is configured to prevent fluid communication between the chambers 1132 adjacent the bladder valve 1137. In an embodiment, each bladder valve 1137 is a pneumatic pinch valve of an annular or donut shape and a pneumatic pressure within each bladder valve 1137 controls the state of the bladder valve 1137. When there is no pneumatic pressure on the bladder valve 1137, the bladder valve 1137 is uninflated and in the open state. When the bladder valve 1137 is uninflated and in the open state, the bladder valve 1137 defines a central opening or an orifice 1135 through the bladder valve 1137, as best viewed in FIG. 12B. Accordingly, when the bladder valve 1137 is in the open state, the central opening 1135 permits the fluidic mass 1130 to pass through the bladder valve 1137. When a pneumatic pressure is placed on, or more specifically within the bladder valve 1137, the bladder valve 1137 inflates to the closed state. More specifically, the bladder valve 1137 radially expands inward to occlude or close the central opening 1135, as best viewed in FIG. 12C. Accordingly, when the bladder valve 1137 is in the closed state, movement of the fluidic mass 1130 through the bladder valve 1137 is stopped or prevented. Each bladder valve 1137 may be formed of various elastic materials such as, but not limited to rubber, plastic, vinyl, an electro-active polymer (EAP), or other suitable materials. While each bladder valve 1137 is illustrated in FIGS. 12A-12C with an annular or doughnut shape, this is by way of example and not limitation and the bladder valves 1137 can be of any shape, design, or configuration suitable for the purposes described herein. Examples of pneumatic fluids suitable for use in transitioning the bladder valve 1137 between the open and closed states include, but are not limited to a gas, water, saline, or any other suitable pneumatic fluid. Examples of devices configured to control the pneumatic pressure and accordingly control the rate of inflation or deflation of each bladder valve 1137 include, but are not limited to a single orifice opening to each bladder valve 1137 (the size of each opening is selected to permit a desired rate of inflation/deflation in conjunction with a desired pneumatic pressure), an actuator disposed in the chamber 1132 configured to assist in the expulsion of pneumatic fluid from the corresponding bladder valve 1137, or other suitable devices.

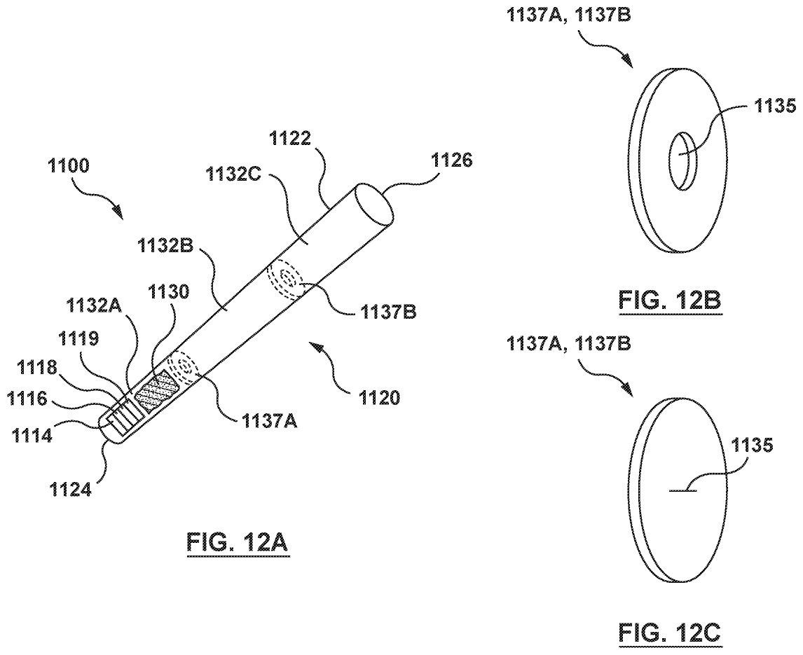

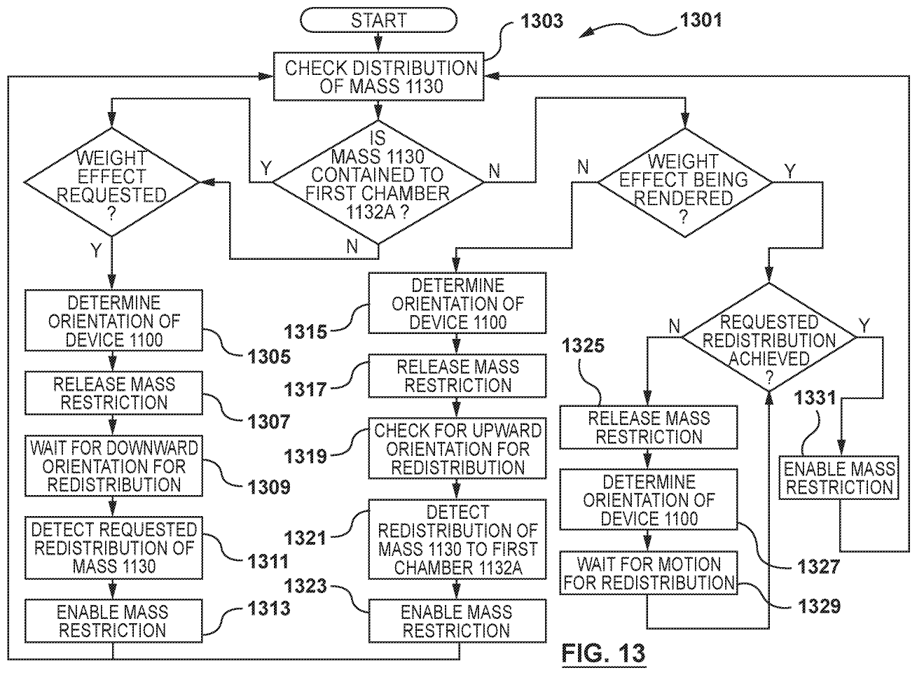

FIG. 13 is a flow chart depicting a process 1301 for providing a haptic feedback indicative of a virtual interaction related to manipulating a virtual object with the hand-held device 1100 in accordance herewith. FIGS. 14A-14C illustrate the interaction of the components of the hand-held device 1100 with reference to the steps of FIG. 13 to provide a haptic feedback to a user to simulate a change in weight of the hand-held device 1100. The local processor 1114, local memory 1116, the first sensor 1118, and the second sensor 1119 have been omitted from FIGS. 14A-14C for clarity. FIG. 14A illustrates the hand-held device 1100 held by a user with a first end 1124 lower than or closer to the ground than a second end 1126. The fluidic mass 1130 is disposed within the first chamber 1132A and restricted therein by the first bladder valve 1137 in the closed state.

To pick up a virtual object, such as a virtual knife, the host processor 1108 and/or the local processor 1114 utilize information in the memory 1110 and/or the local memory 1116 to determine which chamber 1132 the fluidic mass 1130 needs to be restricted within to simulate the virtual knife. In this example, the fluidic mass 1130 needs to be restricted to the second chamber 1132B to simulate the virtual knife. The host processor 1108 and/or the local processor 1114 utilize information from the second sensor 1119 to locate the fluidic mass 1130 in the first chamber 1132A of the elongated housing 1122, as depicted in step 1303 of FIG. 13 and FIG. 14A.

With a weight effect requested (e.g., the user's desire to pick up the virtual knife), the host processor 1108 and/or the local processor 1114 next utilize information from the first sensor 1118 to determine the orientation of the elongated housing 1122 in a step 1305. When the orientation of the elongated housing 1122 has been determined, the host processor 1108 and/or the local processor 1114 send the command signal to the mass restriction device 1120. In response to the command signal, the mass restriction device 1120 decreases a pneumatic pressure on the first bladder valve 1137A. The decrease in pneumatic pressure on the first bladder valve 1137A transitions the first bladder valve 1137A to the open state, thereby removing the restriction to the fluidic mass 1130, as shown in step 1307.

In FIG. 14B, the user manipulates the hand-held device 1100 to place the second end 1126 lower than, or closer to the ground than the first end 1124, as shown in step 1309 of FIG. 13. Once the second end 1126 of the elongated housing 1122 is positioned below the first end 1124, the fluidic mass 1130 moves in a direction indicated by an arrow 1140 towards the second end 1126 due to gravity. The host processor 1108 and/or the local processor 1114 next utilize information from the second sensor 1119 to determine when the fluidic mass 1130 is within the predetermined second chamber 1132B, as shown in step 1311.

When the fluidic mass 1130 is disposed within the second chamber 1132B, the host processor 1108 and/or the local processor 1114 send the command signal to the mass restriction device 1120. In response to the command signal, the mass restriction device 1120 pressurizes the first and second bladder valves 1137A, 1137B. When pressurized, the first and second bladder valves 1137A, 1137B each transition to the closed state. When the first and second bladder valve 1137A, 1137B are each in the closed state, the fluidic mass 1130 is restricted or confined within the second chamber 1132B, as shown in FIG. 14B and in step 1313 of FIG. 13. The movement of the fluidic mass 1130 from the first chamber 1132A to the predetermined second chamber 1132B changes the center of gravity and the moment of inertia of the hand-held device 1100. The changes in the center of gravity and the moment of inertia of the hand-held device 1100 are perceived by the user as an increase in weight of the hand-held device 1100 as the user lifts or otherwise manipulates the virtual knife. When the fluidic mass 1130 is disposed within the second chamber 1132B and restricted therein by the first and second bladder valves 1137A, 1137B each in the closed state, the user can manipulate the hand-held device 1100 as desired and the hand-held device 1100 provides tactile feedback to simulate the user manipulating the virtual knife, as shown in FIG. 14C.

To release the virtual knife, the step 1303 and the steps 1315-1323 are performed to redistribute the fluidic mass 1130 to the first chamber 1132A. The changes in the center of gravity and center of inertia when the fluidic mass 1130 returns to the first chamber 1132A are perceived by the user as a decrease in weight to simulate the user dropping or releasing the virtual knife. Alternatively, when the fluidic mass 1130 is not disposed within the first chamber 1132A and a weight effect is being rendered, the step 1303 and the steps 1325-1329 or the step 1331 can be utilized to provide haptic feedback to the user.

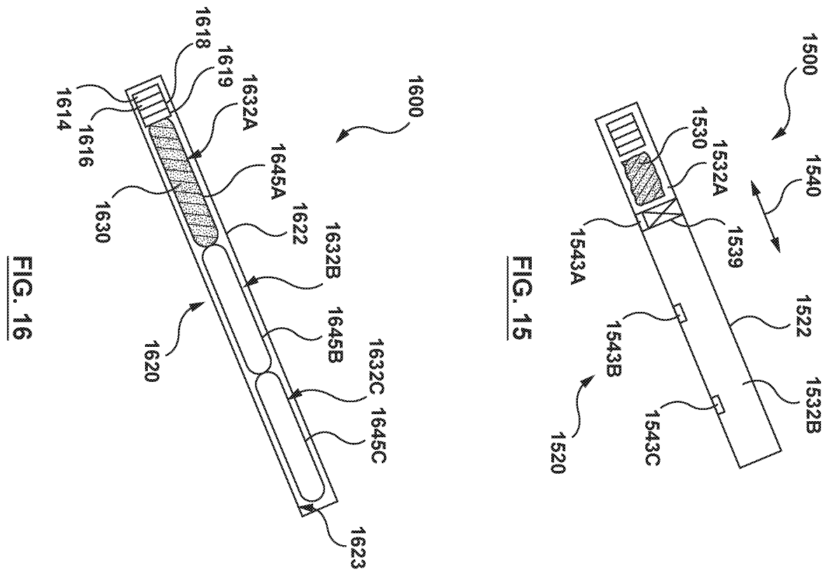

FIG. 16 illustrates a hand-held device 1600 according to another embodiment hereof. The hand-held device 1600 includes an elongated housing 1622, a mass restriction device 1620, a fluidic mass 1630, a local processor 1614, a local memory 1616, a first sensor 1618 and a second sensor 1619. The hand-held device 1600, the elongated housing 1622, the fluidic mass 1630, a local processor 1614, a local memory 1616, the first sensor 1618, and the second sensor 1619 are similar to the hand-held device 1100, the elongated housing 1122, the local processor 1114, the local memory 1116, the fluidic mass 1130, the first sensor 1118, and the second sensor 1119 previously described. Therefore, details and alternatives of the similar components of the hand-held device 1600, the elongated housing 1622, the fluidic mass 1630, the local processor 1614, the local memory 1616, the first sensor 1618, and the second sensor 1619 will not be repeated.

In the hand-held device 1600 of FIG. 16, each chamber 1632 of the elongated housing 1622 is defined by a deformable bladder 1645. More specifically, the elongated housing 1622 includes a first deformable bladder 1645A defining a first chamber 1632A, a second deformable bladder 1645B defining a second chamber 1632B, and a third deformable bladder 1645C defining a third chamber 1632C. The first, second, and third deformable bladders 1645A, 1645B, and 1645C are herein referred to collectively as deformable bladders 1645. Each deformable bladder 1620 may be coupled to an inner surface 1623 of the elongated housing 1622, but such coupling is not required. While shown with three (3) deformable bladders 1645A, 1645B, and 1645C, this is by way of example and not limitation. In an alternative embodiment, the hand-held device 1600 may no fewer than two (2) deformable bladders and can have more than three (3) deformable bladders 1645.

Thus, in this embodiment, each chamber 1632 is structurally separated from the adjacent chambers 1632 via the sidewalls of each corresponding deformable bladder 1645 of the mass restriction device 1620. While each deformable bladder 1645 is shown disposed in a specific location within the elongated housing 1622, and the deformable bladders 1645 are shown as approximately the same size or length, this is by way of example and not limitation. The deformable bladders 1645 may be disposed at any location within the elongated housing 622 suitable for the purposes described herein, and may be of different sizes, shapes, or lengths to define chambers of different sizes, shapes, or lengths.

Each deformable bladder 1645 is in fluid communication with an adjacent deformable bladder 1645, and each deformable bladder 1645 is configured to sealingly receive the fluidic mass 1630 therein. The mass restriction device 1620 is configured to restrict the fluidic mass 1630 within a predetermined deformable bladder 1620 in response to a command signal. More particularly, the mass restriction device 1620 is configured to receive a command signal that is indicative of a virtual interaction. In response to the command signal, the mass restriction device 1620 actuates at least one of the deformable bladders 1620 to restrict the fluidic mass 1630 within a predetermined deformable bladder 1645. Restriction of the fluidic mass 1630 to the predetermined deformable bladder 1645 provides a change in a center of gravity and a change in a moment of inertia of the hand-held device 1600. The change in the center of gravity and moment of inertia are perceived by a user as a change in weight of the hand-held device 1600. The perceived change in weight of the hand-held device 1600 simulates lifting or otherwise manipulating a specific virtual object as previously described with respect to embodiments described above.

More particularly, each deformable bladder 1620 includes an open state when the deformable bladder 1620 is configured to permit fluid communication between the chambers 1632 adjacent the deformable bladder 1620, and a closed state when the deformable bladder 1620 is configured to prevent fluid communication between the chambers 1632 adjacent the deformable bladder 1620. In an embodiment, a pneumatic pressure within each deformable bladder 1620 controls the state of the deformable bladder 1620. When there is no pneumatic pressure on the deformable bladder 1620, the deformable bladder 1620 includes an opening that is in the open state. In an embodiment, each deformable bladder 1620 may further include a valve (such as a valve described herein for valve 633) disposed within or otherwise incorporated into the deformable bladder 1620. When the deformable bladder 1620 is in the open state, the deformable bladder 1620 permits the fluidic mass 1630 to pass through the opening of the deformable bladder 1620. When a pneumatic pressure is placed on, or more specifically within deformable bladder 1620, the deformable bladder 1620 deforms to the closed state in which the opening thereof is sealed or closed, and movement of the fluidic mass 1630 through the deformable bladder 1620 is stopped or prevented. Each deformable bladder 1620 may be formed of various elastic materials such as, but not limited to rubber or other suitable materials. Examples of pneumatic fluids suitable for use in transitioning the deformable bladder 1620 between the open and closed states include, but are not limited to a gas.

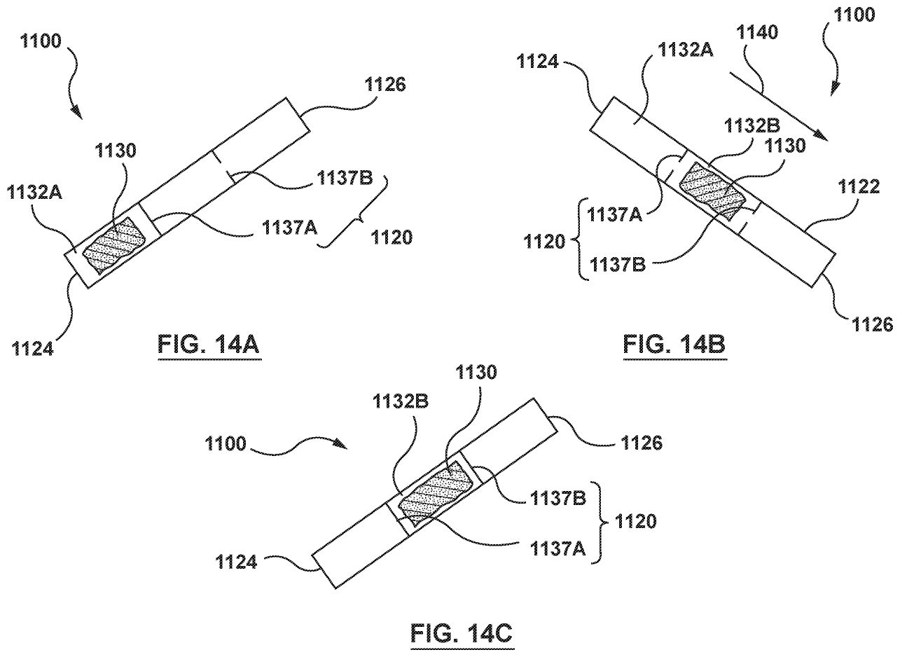

FIG. 15 illustrates a hand-held device 1500 for providing haptic feedback according to another embodiment hereof. The hand-held device 100 includes a mass restriction device 1520 having a magnetic control valve 1539. The magnetic control valve 1539 is a control valve formed of a magnetic material, preferable examples of which include, but are not limited to iron, nickel, cobalt, or other materials suitable for the purposes described herein. The magnetic control valve 1539 is slidably disposed within an elongated housing 1522 of the hand-held device 1500. The magnetic control valve 1539 includes an open state configured to permit fluid communication between adjacent chambers 1532A and 1532B, and a closed state configured to prevent fluid communication between the adjacent chambers 1532A and 1532B. The mass restriction device 1520 is configured to transition the magnetic control valve 1539 between the open and closed states in response to a command signal.

The mass restriction device 1520 further includes a first electromagnet 1543A, a second electromagnet 1543B, and a third electromagnet 1543C (herein referred to collectively as electromagnets 1543). Each electromagnet 1543 is disposed along a length of the elongated housing. The electromagnets 1543 are similar to the electromagnets 121 of FIGS. 1-5C, and therefore details and alternatives of the electromagnets 1543 will not be repeated here in detail. Each electromagnet 1543 includes an unenergized state configured to permit the magnetic control valve 1539 to slide unimpeded within the elongated housing 1522, and an energized state configured to restrict the magnetic control valve 1539 to a location within the elongated housing 1522 adjacent the electromagnet 1543 in the energized state. When the electromagnets 1543 are each in the unenergized state, the magnetic control valve 1539 can freely move or slide within the elongated housing 1522 in either direction as indicated by the arrow 1540 by gravity. However, when one of the electromagnets 1543 is in the energized state, the magnetic control valve 1539 can be restricted to a specific location that is adjacent an electromagnet 1543 in the energized state. The mass restriction device 1520 is further configured to transition at least one electromagnet 1543 between the unenergized and energized states in response to a command signal. This configuration permits a single magnetic control valve 1543 to be utilized in multiple positions along the length of the elongated shaft 1522 such that the shape and the volume of each chamber 1532 can be continuously varied or changed.

In the embodiment of FIG. 15, the magnetic control valve 1539 is restricted adjacent the first electromagnet 1543 by the first electromagnet 1543 in the energized state. Further, the fluidic mass 1530 is restricted in the first chamber 1532A by the magnetic control valve 1539 in the closed state. Transition of the magnetic control valve 1539 between the open and closed states is controlled by the mass restriction device 1520 in response to the command signal, as previously described with respect to the embodiments described above. Further, the transition of each electromagnet 1543 between the energized and unenergized states is controlled by the mass restriction device 1520 in response to the command signal. In an embodiment, when a weight effect is requested, in response to the command signal, the mass restriction device 1520 transitions a predetermined electromagnet 1543 to the energized state. The magnetic control valve 1539 (in an open configuration) is attracted the electromagnet 1543 in the energized state. When the magnetic control valve 1539 is at the predetermined location, and the fluidic mass 1530 is in one or more predetermined chambers 1532, in response to the command signal the mass restriction device 1520 transitions the magnetic control valve 1539 to the closed configuration to restrict the fluidic mass 1530 to the one or more predetermined chambers 1532. Redistribution of the fluidic mass 1530 in the embodiments described herein effects a change in a center of gravity and a moment of inertia of the hand-held device 1500. The changes in the center of gravity and the moment of inertia are perceived by a user as a change in weight of the hand-held device 1500. While the embodiment of hand-held device 1500 of FIG. 15 is described with three (3) electromagnets 1543A, 1543B, and 1543C, this is by way of example and not limitation and it shall be understood that more or fewer electromagnets 1543 may be utilized.

While the embodiment of hand-held device 1500 of FIG. 15 is described with the positioning of the magnetic control valve 1539 occurring prior to transitioning the magnetic control valve 1539 to the closed configuration to restrict the fluidic mass 1530 to the one or more predetermined chambers 1532, it will be understood by one of ordinary skill in the art that the positioning of the magnetic control valve 1539 may occur after transitioning the magnetic control valve 1539 to the closed configuration. Thus, in another embodiment, when a weight effect is requested, in response to the command signal, the mass restriction device 1520 transitions the magnetic control valve 1539 to the closed configuration to restrict the fluidic mass 1530 to the one or more predetermined chambers 1532. When the fluidic mass is restricted to the one or more predetermined chambers, the mass restriction device 1520 transitions a predetermined electromagnet 1543 to the energized state in response to the command signal. The magnetic control valve 1539 (in the closed configuration) is then attracted the electromagnet 1543 in the energized state. Objects of high mass/weight may require the magnetic control valve 1539 to be in the open configuration when repositioning to allow for faster redistribution), while lighter objects of relatively lower mass/weight may permit the magnetic control valve 1539 to be in the closed configuration when repositioning.

In the embodiment of FIG. 15, each chamber 1532 is defined by the magnetic control valve 1539 and an end of the elongated housing 1522. Thus, in this embodiment, each chamber 1532A is structurally separated from the adjacent chamber 1532B via the magnetic control valve 1539 of the mass restriction device 1520. However, since the magnetic control valve 1539 is slideable within the elongated housing 1522, the length or size of each chamber 1532 depends upon the location of the magnetic control valve 1539 within the elongated housing, which depends upon a magnetic field of a corresponding electromagnet of the mass restriction device 1520.

In an embodiment hereof, the hand-held device according to any embodiment hereof may be configured as a wearable device. More particularly, rather than being configured to be held within a hand of a user as described above, the device may be configured to be affixed or secured to a portion of a user's body such as, e.g., a user's forearm. When configured to be a wearable device, the handle portion of the device (which initially contains the fluidic mass 130 and may be considered to be a reservoir) is located centrally along the length of the elongated housing (e.g., at a midsection of the elongated housing rather than an end thereof) so as not to alter the user's center of gravity for the user's arm. The chambers of the wearable device are located on both sides of the central handle portion such that at least one chamber is located to the right of the central handle portion and at least one chamber is located to the left of the central handle portion.

Additional types of mass restriction devices and/or masses may be included with any embodiment described herein. For example, and not by way of limitation, a thermal actuator assembly may be utilized to restrict movement of a non-Newtonian mass in embodiments hereof. Stated another way, a non-Newtonian fluid can be used as the fluidic mass in conjunction with a mass restriction device configured to control a temperature of the mass in order to control the distribution of the mass within the hand-held device. Examples of thermal actuators for restricting non-Newtonian masses include, but are not limited to a Peltier device. In an embodiment, the thermal actuator assemblies can replace or enhance the valve assemblies described in embodiments hereof to control the rate and amount of fluidic mass redistribution by replacing or enhancing the valve setups described herein with fluids having varying viscosities at different temperatures. Stated another way, for fluids that having varying viscosities at different temperatures, thermal actuator assemblies enable additional methods for controlling the rate and amount of fluid redistribution within the hand-held device by replacing or enhancing the valve assemblies described herein with temperature altering actuators.

While various embodiments have been described above, it should be understood that they have been presented only as illustrations and examples of the present invention, and not by way of limitation. It will be apparent to persons skilled in the relevant art that various changes in form and detail can be made therein without departing from the spirit and scope of the invention. Thus, the breadth and scope of the present invention should not be limited by any of the above-described exemplary embodiments but should be defined only in accordance with the appended claims and their equivalents. It will also be understood that each feature of each embodiment discussed herein can be used in combination with the features of any other embodiment. All patents and publications discussed herein are incorporated by reference herein in their entirety.

What is claimed is:

1. A hand-held device for providing haptic feedback, comprising:
an elongated housing configured to be held by a user, wherein the elongated housing includes a first end, a second end opposite the first end, and at least two chambers within the elongated housing;
a mass slidably disposed within the elongated housing, wherein the mass is slidable between the at least two chambers by gravity and wherein the mass is formed from a ferrous material;
a mass restriction device that includes an electromagnet disposed within the elongated housing, the electromagnet including an unenergized state configured to permit the mass to slide within the elongated housing and an energized state configured to restrict at least a portion of the mass within one of the at least two chambers;
a first sensor configured to sense an orientation of the elongated housing; and
a second sensor configured to sense a location of the mass within the elongated housing relative to the at least two chambers,
wherein the mass restriction device is further configured to receive a command signal and is configured to transition the electromagnet between the unenergized state and the energized state in response to the command signal.

2. The hand-held device of claim 1, wherein the command signal is indicative of a virtual interaction related to manipulating a virtual object and the mass restriction device is configured to simulate a perceived change in weight of the hand-held device as the virtual object is manipulated by the user.

3. The hand-held device of claim 1, wherein the at least two chambers include a plurality of chambers.

4. The hand-held device of claim 1, wherein the at least two chambers are defined by a magnetic field of the electromagnet in the energized state.

5. The hand-held device of claim 1, wherein the mass is a ferrofluid.

6. The hand-held device of claim 1, wherein the mass is a plurality of ferrous objects.

7. The hand-held device of claim 1, wherein the mass includes a plurality of ferrous solid objects suspended within a fluid.

8. The hand-held device of claim 1, wherein the at least two chambers are disposed eccentric relative to a longitudinal axis of the elongated housing.

9. The hand-held device of claim 1, further comprising a local processor, wherein the local processor is configured to receive information from the first sensor and the second sensor.

10. The hand-held device of claim 9, wherein the local processor is further configured to send the command signal to the mass restriction device.

11. A hand-held device for providing haptic feedback, comprising:
an elongated housing configured to be held by a user, wherein the elongated housing includes a first end, a second end opposite the first end, and at least two chambers within the elongated housing;
a mass slidably disposed within the elongated housing, wherein the mass is fluidic and slidable between the at least two chambers by gravity;
a mass restriction device including a valve disposed between the at least two chambers of the elongated housing, wherein the valve includes an open state configured to permit fluid communication between the chambers adjacent the valve and a closed state configured to prevent fluid communication between the chambers adjacent the valve, and wherein the valve transitions between the open state and the closed state in response to a command signal;
a first sensor configured to sense an orientation of the elongated housing; and
a second sensor configured to sense a location of the mass within the elongated housing relative to the at least two chambers.

12. The hand-held device of claim 11, wherein the valve is a magnetic control valve slidably disposed within the elongated housing and the mass restriction device further includes at least one electromagnet disposed along a length of the elongated housing, the at least one electromagnet including an unenergized state configured to permit the magnetic control valve to slide unimpeded along the length of the elongated housing and an energized state configured to restrict the magnetic control valve to a location within the elongated housing adjacent the at least one electromagnet in the energized state.

13. The hand-held device of claim 12, wherein the mass restriction device is further configured to transition the at least one electromagnet between the unenergized state and the energized state in response to the command signal.

14. The hand-held device of claim 11, wherein the valve is a bladder valve, and inflation of the bladder valve transitions the bladder valve between the open state and the closed state.

15. The hand-held device of claim 11, wherein the valve is a control valve configured to control fluid flow by varying a size of a flow passage of the control valve as directed by the command signal.

16. The hand-held device of claim 11, further comprising a local processor, wherein the local processor is configured to receive information from the first sensor and the second sensor and is further configured to send the command signal to the mass restriction device.

17. A system for providing haptic feedback, comprising:
a processor for generating a command signal indicative of a virtual interaction related to manipulating a virtual object; and
a hand-held device including:
an elongated housing including a first end, a second end opposite the first end, and at least two chambers within the elongated housing;
a mass slidably disposed within the elongated housing, wherein the mass is formed from a ferrous material;
a mass restriction device that includes an electromagnet disposed within the elongated housing, the electromagnet including an unenergized state configured to permit the mass to slide within the elongated housing and an energized state configured to restrict at least a portion of the mass within one of the at least two chambers;
a first sensor configured to sense an orientation of the hand-held device; and
a second sensor configure to sense a location of the mass within the elongated housing relative to the at least two chambers,
wherein when the user changes the orientation of the hand-held device to manipulate the virtual object, the mass within the elongated housing of the hand-held device moves between the chambers by gravity, and
wherein the mass restriction device is further configured to transition the electromagnet between the unenergized state and the energized state in response to the command signal.

18. The system of claim 17, wherein the processor is further configured to receive information from the first sensor and the second sensor.

19. The system of claim 18, wherein the processor is a local processor disposed within the elongated housing.

20. The system of claim 18, wherein the processor is a host processor disposed outside of the elongated housing.
